(19) United States
(12) Patent Application Publication
(10) Pub. No.: US 2016/0312072 A1
(43) Pub. Date: Oct. 27, 2016

(54) ADHESIVE MEMBER

(71) Applicant: CANON KABUSHIKI KAISHA, Tokyo (JP)

(72) Inventors: Yoji Yamamoto, Hachioji-shi (JP); Hajime Sato, Tokyo (JP)

(21) Appl. No.: 15/132,648

(22) Filed: Apr. 19, 2016

(30) Foreign Application Priority Data
Apr. 23, 2015 (JP) 2015-088070

(51) Int. Cl. C09J 7/02

(52) U.S. Cl. CPC C09J 7/02; C09J 2201/626

(57) ABSTRACT

Provided is an adhesive member whose adhesive force has relatively strong directional dependency. Specifically, provided is an adhesive member, which is configured to adhere to an adherend through an intersurface force, wherein when a strain energy release rate is defined as G1^{a} and G2^{a} and an adhesive energy is defined as Δγ1^{a} and Δγ2^{a} respectively, at least one of an elastic modulus or a Poisson's ratio of the adhesive member is nonuniformized so that G1^{a}/Δγ1^{a}≠G2^{a}/Δγ2^{a} is satisfied.

### BACKGROUND OF THE INVENTION

1. Field of the Invention

The present invention relates to an adhesive member, and more particularly, to an adhesive member whose adhesive force has such directional dependency that the member strongly adheres for a force in a specific direction and shows a weak adhesive force for a force in another direction.

2. Description of the Related Art

An adhesive member is often required to have an additionally strong adhesive force, high durability, and high heat resistance, and its development aimed at the satisfaction of the requirement has been progressed. However, in terms of recycling in which an attempt is made to effectively utilize limited resources, an adhesive member that can be easily peeled and reused when one wishes to peel the adhesive member is useful. Accordingly, such an adhesive member that its adhesive force largely changes in accordance with a direction in which a force is applied, and hence proper selection of the direction in which the force is applied enables easy peeling of the member while strongly adhering the member, i.e., an adhesive member whose adhesive force has directional dependency has started to be required. In the biological world, the adhesive force of a leg of a gecko has directional dependency, and the gecko is known to walk while repeating adhesion and peeling at a high speed by utilizing the feature. In view of the foregoing, as an artificial adhesive member imitating the fine structure of the leg surface of the gecko, there have been reported several examples in each of which the surface shape of the adhesive surface of an adhesive member is provided with a characteristic.

In M. Murphy, B. Aksak, and M. Sitti, “Adhesion and Anisotropic Friction Enhancement of Angled Heterogeneous Micro-Fiber Arrays with Spherical and Spatula Tips” Journal of Adhesion Science and Technology, vol. 21, no. 12-13, pp. 1281-1296, 2007, there is a disclosure of an adhesive member having an array of inclined columnar structural products whose vertical sectional shapes are asymmetrized. According to the above-mentioned literature, an adhesive force in a direction parallel to the adhesive surface of the member has some degree of directional dependency, and it has been shown that when such a force in a horizontal direction that the columnar structural products are pulled is applied, the member strongly adheres, and when such a force in the horizontal direction that the columnar structural products are compressed is applied, the adhesive force is weak.

In addition, in Japanese Patent Application Laid-Open No. 2009-70883, there is similarly a disclosure of an adhesive member having an array of inclined columnar structural products. According to the above-mentioned literature, the adhesive member can be peeled from an adherend in a relatively easy manner without any adhesive residue. Meanwhile, in each of D. Santos, M. Spenko, A. Parness, S. Kim, and M. Cutkosky, “Directional adhesion for climbing: theoretical and practical considerations” Journal of Adhesion Science and Technology, vol. 21, no. 12-13, 1317-1341, 2007, and Japanese Patent Application Laid-Open No. 2012-245748, there is a disclosure of an adhesive member having an array of columnar structural products whose tips are cut into wedge shapes. In the adhesive member, the directional dependency of its adhesive force is improved by utilizing an internal stress generated when the tip portions of the wedge shapes deform to adhere to an adherend.

Each of those approaches requires such processing that the structures of the many columnar structural products on the surface of the adhesive member are provided with characteristics, and is hence liable to take a great deal of time and labor. Therefore, the realization of the directional dependency of an adhesive force by an additionally simple method has been desired.

It is hard to say that the directional dependency of an adhesive force is easily improved by the related-art approach adhering an adhesive member to an adherend merely through the use of an inclined columnar structural product. In addition, it is liable to take a great deal of time and labor to produce the adhesive member having the array of the columnar structural products whose tips are cut into wedge shapes.

### SUMMARY OF THE INVENTION

In view of the problems, an object of the present invention is to provide, in an additionally simple manner, an adhesive member whose adhesive force has relatively strong directional dependency.

An adhesive member according to one embodiment of the present invention is an adhesive member, which is configured to adhere to an adherend through an intersurface force, the adhesive member having the following feature. When a strain energy release rate at a first peeling site of the adhesive member and an adhesive energy at the first peeling site in a case where a force is applied in a first direction parallel to an adhesive surface thereof are defined as G1^{a} and Δγ1^{a}, respectively, and a strain energy release rate at a second peeling site of the adhesive member and an adhesive energy at the second peeling site in a case where a force having the same magnitude as that of the force applied in the first direction is applied in a second direction opposite to the first direction are defined as G2^{a} and Δγ2^{a}, respectively, at least one of an elastic modulus and a Poisson's ratio of the adhesive member is nonuniformized so that G1^{a}/Δγ1^{a}≠G2^{a}/Δγ2^{a} is satisfied.

Further features of the present invention will become apparent from the following description of exemplary embodiments with reference to the attached drawings.

### BRIEF DESCRIPTION OF THE DRAWINGS

FIG. 1A, FIG. 1B, FIG. 1C, FIG. 1D, FIG. 1E, and FIG. 1F are views for illustrating the directional dependency of the adhesive force of an adhesive member in an embodiment and an example of the use of the adhesive member.

FIG. 2A and FIG. 2B are views for illustrating examples of the construction of the adhesive member in the embodiment.

FIG. 3A and FIG. 3B are views for illustrating the reason why the directional dependency appears in the adhesive force through the nonuniformization of an elastic modulus.

FIG. 4A and FIG. 4B are views for illustrating examples of the construction of an adhesive member including a substrate portion configured to support a plurality of protruding portions.

FIG. 5A and FIG. 5B are views for illustrating examples of an asymmetrized horizontal sectional shape.

FIG. 6 is a view for illustrating the reason why the directional dependency appears in the adhesive force through the asymmetrization of the horizontal sectional shape.

FIG. 7 is a view of an example of an adhesive member whose adhesive surface includes a plurality of regions having a uniform adhesive energy.

FIG. 8 is an explanatory view of the definition of a virtual adhesive member whose vertical sectional shape is assumed to be bilaterally symmetric.

FIG. 9 is an explanatory view of a method of calculating a strain energy release rate in each of Examples and Reference Examples.

FIG. 10 is an explanatory view of a region division method for the entirety of a model when the strain energy release rate is calculated in each of Examples and Reference Examples.

FIG. 11 is an explanatory view of a method of calculating the adhesion profile of an adhesive member in each of Examples and Reference Examples.

FIG. 12A, FIG. 12B, FIG. 12C, FIG. 12D, FIG. 12E, and FIG. 12F are views for illustrating analysis model shapes in Examples and Reference Examples.

FIG. 13 is a graph for showing the result of the analysis of the adhesion profile of the adhesive member.

FIG. 14 is a graph for showing the result of the analysis of the adhesion profile of the adhesive member.

FIG. 15 is a graph for showing the result of the analysis of the adhesion profile of the adhesive member.

FIG. 16 is a graph for showing the result of the analysis of the adhesion profile of the adhesive member.

FIG. 17 is a graph for showing the result of the analysis of the adhesion profile of the adhesive member.

FIG. 18 is a graph for showing the result of the analysis of the adhesion profile of the adhesive member.

FIG. 19 is a graph for showing the result of the analysis of the adhesion profile of the adhesive member.

FIG. 20 is a graph for showing the result of the analysis of the adhesion profile of the adhesive member.

FIG. 21 is a graph for showing the result of the analysis of the adhesion profile of the adhesive member.

FIG. 22 is a graph for showing the result of the analysis of the adhesion profile of the adhesive member.

FIG. 23 is an image obtained by observing an adhesive member including protruding portions with a SEM.

FIG. 24A and FIG. 24B are explanatory views of a method of producing an adhesive energy difference between the first and second peeling sites of an adhesive surface through VUV irradiation.

FIG. 25 is a view for illustrating a method of measuring the adhesion profile of the adhesive member.

FIG. 26A and FIG. 26B are graphs for showing the results of the measurement of the adhesion profile of the adhesive member.

FIG. 27A and FIG. 27B are views for illustrating the construction of an adhesive member of an example whose elastic modulus is nonuniformized.

FIG. 28A, FIG. 28B, and FIG. 28C are views for illustrating a production process for the adhesive member of the example whose elastic modulus is nonuniformized.

FIG. 29 is a view for illustrating a method of evaluating the adhesive force of the adhesive member of the example whose elastic modulus is nonuniformized.

### DESCRIPTION OF THE EMBODIMENTS

Preferred embodiments of the present invention will now be described in detail in accordance with the accompanying drawings.

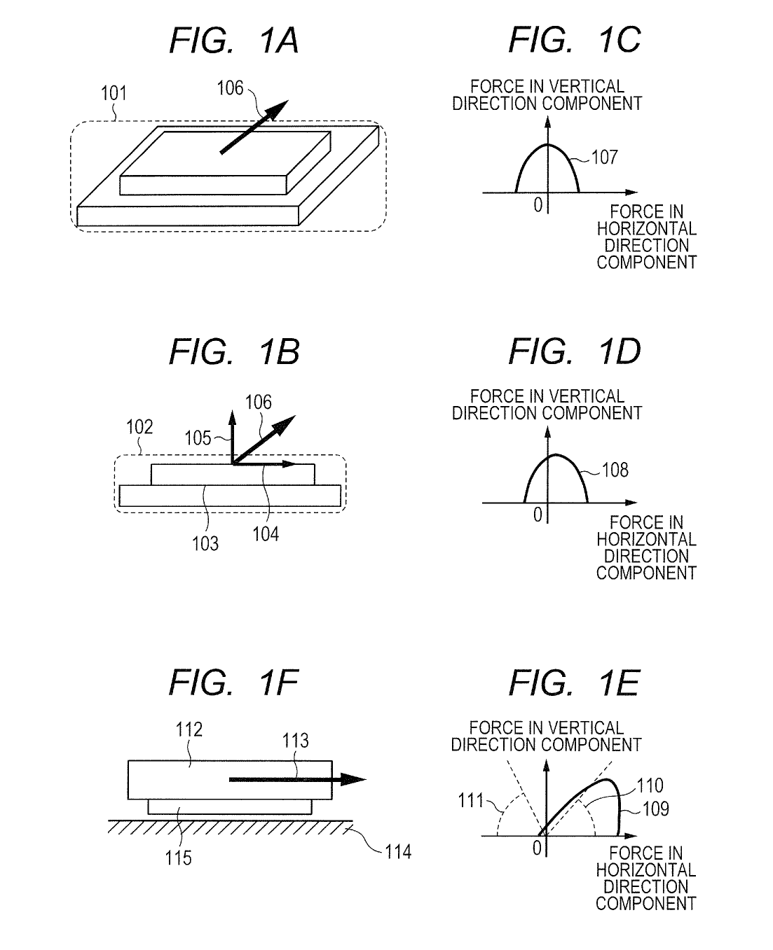

Prior to specific description of an adhesive member of the present invention, the definition of the directional dependency of its adhesive force closely related to the present invention is described with reference to FIG. 1A, FIG. 1B, FIG. 1C, FIG. 1D, FIG. 1E, and FIG. 1F. First, as illustrated in FIG. 1A, an adhesive force (106) when a composite (101) formed of a certain adhesive member and an adherend is pulled in a direction forming an arbitrary angle relative to an adhesive interface (103) is considered. FIG. 1B is a sectional view of FIG. 1A. Further, the adhesive force is decomposed into a force in a horizontal direction component (104) and a force in a vertical direction component (105), and the forces are plotted in a two-dimensional plane as illustrated in FIG. 1C to FIG. 1E (107 to 109, the two-dimensional plots are each hereinafter referred to as “adhesion profile”).

In the case of a composite that does not have an asymmetric shape or asymmetric properties in the horizontal direction, the adhesion profile is always bilaterally symmetric in the horizontal direction (FIG. 1C). On the other hand, in the case of a composite having some asymmetry in a certain horizontal direction, the adhesion profile may be asymmetric in the horizontal direction (FIG. 1D). The property by virtue of which a composite shows such asymmetric adhesion profile is called the directional dependency of the adhesive force. When the directional dependency of the adhesive force can be improved by properly designing a composite, for example, an adhesive composite having such adhesion profile as illustrated in FIG. 1E can be realized. In this case, the composite shows a strong adhesive force when pulled at an angle in a range represented by reference numeral 110, but shows only a weak adhesive force when pulled at an angle in a range represented by reference numeral 111 in a substantially opposite direction. That is, proper selection of the direction in which a force is applied enables strong adhesion of the composite or the peeling thereof with a weak force. The present invention provides such adhesive member whose adhesive force has relatively high directional dependency.

An adhesive member having the following characteristic is suitably used as the adhesive member whose adhesive force has directional dependency: the ratio of the maximum adhesive force of the adhesive member in the range represented by reference numeral 110 to the minimum adhesive force thereof in the range represented by reference numeral 111 is 2 or more. An adhesive member in which the ratio is 5 or more is more suitably used.

The adhesive member whose adhesive force has directional dependency of the present invention can be utilized in various ways. For example, when one wishes to removably fix an object (112) on a surface (114) parallel to the direction of an external force, such as gravity, or an inertial force (113), an adhesive member (115) is used by being mounted on the object (FIG. 1F). A situation where the object is temporarily attached to a vertical wall, or a shift between a gripping tool or a conveying stage and the object is prevented in high-acceleration conveyance of the object corresponds to the foregoing. In this case, the adhesive member is desirably mounted so that the direction of the external force or the inertial force is included in the range where the adhesive force of the adhesive member is strong.

Further, as another example, a combination of a plurality of adhesive members can be used as such adhesive device as described in Japanese Patent Application Laid-Open No. 2014-107319. The usage method is particularly effective in fixing the object onto a surface perpendicular to the direction of the external force or the inertial force.

In each of the examples, the adhesive member needs to show a significant adhesive force in the range represented by reference numeral 110 of FIG. 1E, and its maximum adhesive strength in the range is desirably 1 g/cm² or more.

Next, the construction of an adhesive member in an embodiment of the present invention is described. The adhesive member of the present invention is an adhesive member configured to adhere to an adherend through an intersurface force. In addition, a strain energy release rate at the first peeling site of the adhesive member and an adhesive energy at the first peeling site in the case where a force is applied in a first direction parallel to the adhesive surface of the adhesive member are defined as G1^{a} and Δγ1^{a}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{a} and Δγ2^{a}, respectively. In this case, the elastic modulus or/and Poisson's ratio of the adhesive member is/are nonuniformized so that G1^{a}/Δγ1^{a}≠G2^{a}/Δγ2^{a} is satisfied.

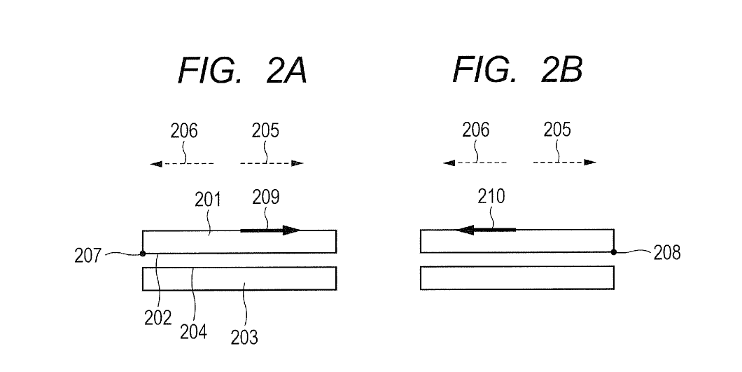

The construction of the adhesive member in this embodiment is described with reference to FIG. 2A and FIG. 2B. An adhesive member (201) adheres to an adherend (203) through an intersurface force between an adhesive surface (202) thereof and a surface (204) of the adherend. Here, the intersurface force refers to a force strongly depending not on a distance between the centers of gravity of two objects but on a distance between their surfaces among the interaction forces between the objects. A typical example thereof is an interaction force based on an intermolecular force. In a typical example of the present invention, the adhesive member can be an elastic body structural product. The elastic body structural product is a structural product in which elastic behavior is more dominant than viscous behavior is. With such structural product, the dissipation of an energy by the viscous behavior is relatively reduced, and hence the directional dependency of the adhesive force of the member easily appears via a mechanism to be described later.

As a rough guideline, a value for the loss tangent tan δ of the adhesive member is desirably 0.3 or less in an observation time (time taken to peel the adhesive member) and a temperature set from a practical viewpoint. A polymer resin is suitable as a component for imparting an elastic property to the adhesive member because the resin has a moderate elastic modulus and shows elastic behavior over a wide strain range. As a material for constituting the adhesive member, there may be suitably given, for example, polydimethylsiloxane (PDMS), polyurethane (PU), polymethyl methacrylate (PMMA), and analogs thereof.

The adhesive member can be constructed from a plurality of parts. In that case, an assembly of the parts is regarded as the adhesive member. With such construction, the nonuniformization of various physical properties of the member described in this specification and the asymmetrization of its shape can be simply realized because it is sufficient to change physical properties and a shape from part to part.

Next, a peeling site is described. The site from which the peeling of the adhesive member starts in the case where the adhesive member is peeled from the adherend while a force is applied to the adhesive member in a first direction (205) parallel to the adhesive surface (202) differs from that in the case where the adhesive member is peeled from the adherend while a force is applied thereto in a second direction (206) opposite to the first direction. The peeling sites are defined as a first peeling site (207) and a second peeling site (208), respectively. Such property by virtue of which the adhesive member has different peeling sites in accordance with the direction in which the force is applied is derived from the following characteristic: the adhesive member adheres to the adherend through the intersurface force. When the adhesive surface of the adhesive member is a flat surface, the first direction parallel to the adhesive surface of the adhesive member is literally a direction parallel to the flat surface, but when the adhesive surface is a curved surface, the direction may be interpreted as the tangential direction of the curved surface. For example, when the adhesive surface is a cylindrical side surface, a spherical surface, or a shape close to part of any such surface, the direction can be considered to be the direction in which torque is generated around the center of a cylinder or a sphere.

Here, the strain energy release rate and the adhesive energy at the first peeling site in the case where a force (209) in the first direction is applied are defined as G1^{a} and Δγ1^{a}, respectively. In addition, the strain energy release rate and the adhesive energy at the second peeling site in the case where a force (210) in the second direction having the same magnitude as that of the force in the first direction is applied are defined as G2^{a} and Δγ2^{a}, respectively. In the present invention, a strain energy release rate is defined as the amount of an elastic strain energy to be lost when the peeling of one unit area extends. Specifically, the rate is determined from dU/dS where dU represents the amount of an elastic strain energy to be lost when the peeling of a minute area dS extends.

In addition, an adhesive energy is defined as the amount of a change in surface free energy when a new surface is formed by separating two objects A and B adhering to each other on an adhesive surface of one unit area. The energy is determined from ΔγA+ΔγB−ΔγAB where ΔγA and ΔγB represent the surface free energies of the objects A and B, respectively, and ΔγAB represents an interface free energy between the object A and the object B.

The elastic modulus or/and Poisson's ratio of the adhesive member of the present invention is/are nonuniformized so that those physical property values satisfy G1^{a}/Δγ1^{a}≠G2^{a}/Δγ2^{a}. The elastic modulus is defined as a constant of proportionality (stress/strain) between a stress and a strain in the elastic deformation of the member. When the member shows viscous behavior as well, the elastic modulus refers to a storage modulus representing an energy-accumulating effect. In addition, the Poisson's ratio is defined as a ratio between a strain along a uniaxial stress direction when an object is elastically deformed by applying a uniaxial stress and a strain in a direction perpendicular to the uniaxial stress to be secondarily generated. Here, the elastic modulus changes in value depending on a material more largely than the Poisson's ratio does, and hence an adhesive member whose elastic modulus is nonuniformized is suitably used. A member obtained by arranging a void in the adhesive member is also one approach for the nonuniformization in this embodiment because the elastic modulus of the void portion can be considered to be zero. For example, when many voids are arranged in part of the adhesive member, the average elastic modulus of the region reduces, and hence substantially the same effect as that in the case where materials having different elastic moduli are used is obtained.

The reason why the directional dependency appears in the adhesive force through the foregoing construction is described below. First, the magnitude of each of the force in the first direction and the force in the second direction providing the strain energy release rates G1^{a} and G2^{a} is represented by F, the magnitude of an adhesive force in the first direction is represented by F1, and the magnitude of an adhesive force in the second direction is represented by F2. A value for a strain energy release rate is proportional to the square of an applied force, and G1^{a} and G2^{a} represent release rates when a force having a magnitude of F is applied in the first and second directions, respectively. Accordingly, a strain energy release rate at the first peeling site when a force having a magnitude of F1 is applied in the first direction is represented by G1^{a}(F1/F)², and a strain energy release rate at the second peeling site when a force having a magnitude of F2 is applied in the second direction is represented by G2^{a}(F2/F)².

In consideration of an analogy to a theory in linear fracture mechanics, the adhesive member peels from the adherend when the strain energy release rate becomes equal to the adhesive energy. Accordingly, the adhesive forces in the first direction and the second direction are determined to be F1=F(G1^{a}/Δγ1^{a})^{-1/2} and F2=F(G2^{a}/Δγ2^{a})^{-1/2}, respectively by solving G1^{a}(F1/F)²=Δγ1^{a} and G2^{a}(F2/F)²=Δγ2^{a}. It is understood from the foregoing that when G1^{a}/Δγ1^{a}≠G2^{a}/Δγ2^{a} is satisfied, the following effect is expressed: the adhesive forces in the first direction and the second direction differ from each other.

When G1^{a}/Δγ1^{a}<G2^{a}/Δγ2^{a} is satisfied, the adhesive force in the first direction is stronger than the other, and when G1^{a}/Δγ1^{a}>G2^{a}/Δγ2^{a} is satisfied, the adhesive force in the second direction is stronger than the other. As a difference between the G1^{a}/Δγ1^{a} and the G2^{a}/Δγ2^{a} enlarges, the directional dependency of the adhesive member enlarges. Accordingly, for example, an adhesive member in which the ratio of the larger one of the G1^{a}/Δγ1^{a} and the G2^{a}/Δγ2^{a} to the other is 2 or more is suitably used, and an adhesive member in which the ratio is 5 or more is more suitably used.

The strain energy release rates G1^{a} and G2^{a} depend on the shapes, elastic moduli, and Poisson's ratio of the adhesive member and the adherend, and can be easily calculated from structural analysis by, for example, a finite element method or a boundary element method based on these pieces of information. Examples thereof include a method involving determining each of the rates from a stress intensity factor, a method involving determining a J-integral, and a method involving extending minute virtual peeling (corresponding to a virtual crack extension method in fracture mechanics).

When the intersurface force is an interaction force based on an intermolecular force, the adhesive energies Δγ1^{a} and Δγ2^{a} depend on the chemical species of the surfaces of the adhesive member and the adherend. For example, the energies can each be determined by: determining the surface free energies of the peeling sites of the adhesive member and the surface of the adherend through contact angle measurement; and substituting values for a dispersion component, a polar component, and a hydrogen bond component into extended Fowkes' equation. Alternatively, when chemical species forming the peeling sites of the adhesive member and the surface of the adherend are known, each of the energies can be estimated by a molecular dynamics simulation, or can be experimentally measured by a JKR test or the like.

Even when the intersurface force is an interaction force except the intermolecular force, the adhesive energies can each be determined by: determining the amount of work needed for separating the surfaces between which the intersurface force acts from an adhered state to an infinite distance; and converting the amount of work into a value per unit adhesion area.

In this embodiment, as described above, the strain energy release rates and the adhesive energies can be estimated or measured, and hence a person skilled in the art can easily design the nonuniform distribution/distributions of the elastic modulus or/and the Poisson's ratio so that G1^{a}/Δγ1^{a}≠G2^{a}/Δγ2^{a} is satisfied.

Here, the peeling site of the adhesive member when a force is applied in a certain direction can be estimated based on, for example, structural analysis. Specifically, it is appropriate to adopt the following procedure: the distribution of a strain energy release rate G^{a} on the adhesive surface of the adhesive member is determined, and the site at which a ratioG^{a}/Δγ^{a} becomes maximum is determined while the distribution of an adhesive energy Δγ^{a} is taken into consideration. In addition, the peeling site can be determined by actual experimental observation. Accordingly, a person skilled in the art can easily design an adhesive member having different peeling sites in accordance with the direction in which the force is applied. When the certain direction is the first direction, the peeling site at the time of the application of the force in the certain direction is the first peeling site, and when the certain direction is the second direction, the peeling site at the time of the application of the force in the certain direction is the second peeling site.

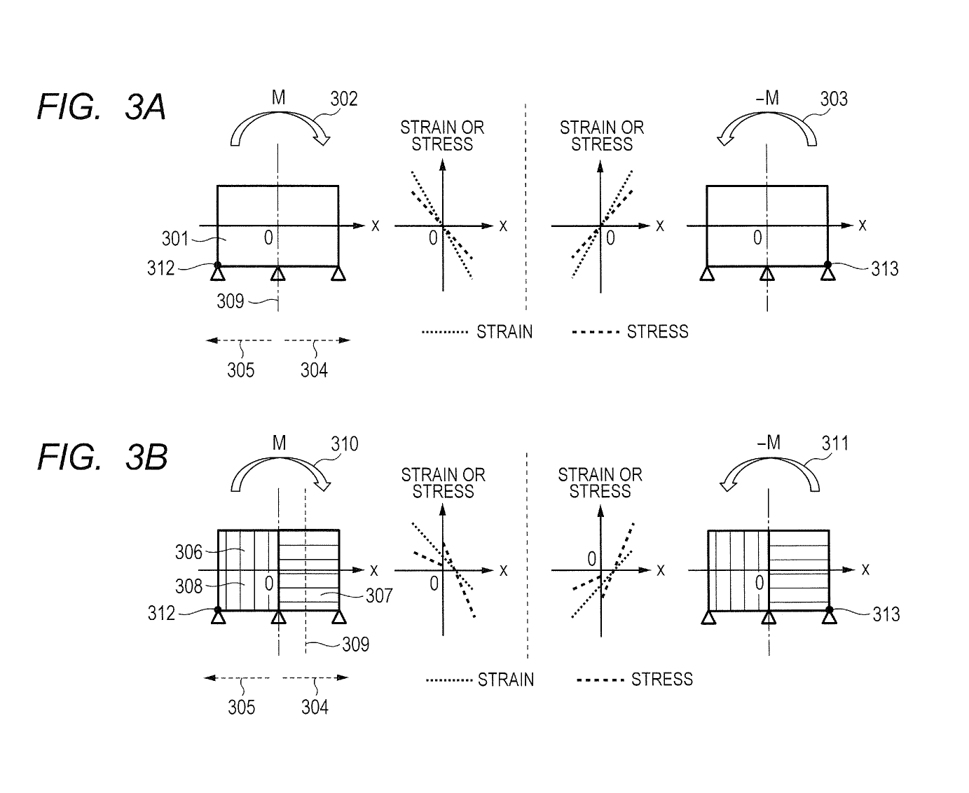

It is because of the following reason that the directional dependency appears in the adhesive force through the nonuniformization of the elastic modulus of the adhesive member. To simplify the description, the adhesive member is assumed to be of a cylindrical shape, and a state in which the bottom surface (adhesive surface) of a cylinder (301) is fixed by being adhered to an adherend as illustrated in FIG. 3A is considered. FIG. 3A and FIG. 3B are illustrations of the cylinder when viewed from its side surface. When a force is applied to the cylinder in a first direction (304) or a second direction (305), bending moments (302, 303) opposite in direction to each other are applied to the cylinder. In the case where the elastic modulus is uniform, a neutral surface (309) where a strain or a stress becomes zero when the bending moments (302, 303) are applied to the tip of the member is the center of the adhesive member, and the absolute values of the strain outside and inside the bending have the same value. Accordingly, the maximum tensile stress has the same value irrespective of the direction of the bending, and hence no directional dependency appears in the adhesive force.

Next, as a cylinder (306) whose elastic modulus is nonuniform, for example, the case where the elastic modulus of a half region (307) on the first direction (304) side is larger than the elastic modulus of a half region (308) on the second direction (305) side is considered (FIG. 3B). In this case, the neutral surface (309) shifts to the first direction side, and hence the absolute value of the strain becomes smaller on the first direction side than on the other side, but the absolute value of the stress becomes larger on the first direction side than on the other side because the effect of the elastic modulus becomes dominant. By virtue of the effect, a tensile stress generated at a second peeling site (313) by a bending moment (311) in which the first direction side becomes outside larger than a tensile stress generated at a first peeling site (312) by a bending moment (310) in which the second direction side becomes outside. Accordingly, G1^{a}/Δγ1^{a}<G2^{a}/Δγ2^{a} is satisfied, and as can be seen from the discussion of the adhesive forces in the first direction and the second direction, such directional dependency that the adhesive force in the first direction becomes stronger than the other appears in the adhesive force. When the magnitude relation of the elastic modulus is reversed, the directional dependency of the adhesive force is also reversed.

In the foregoing discussion, to simplify the description, the adhesive member has been assumed to be of a cylindrical shape. However, the discussion is a discussion that can be extended not only, of course, to a columnar adhesive member whose section is not of a circular shape but also qualitatively to adhesive members of various shapes except a columnar shape. Accordingly, the shape of the adhesive member in this embodiment is not limited to a cylindrical shape. In addition, it has been assumed that an adhesive energy between the adhesive member and the adherend is uniform. However, it is apparent that even when the adhesive energy is nonuniform, proper design of the distribution of the elastic modulus can change a stress distribution in the adhesive member to cause the directional dependency in the adhesive force. Accordingly, this embodiment is not limited to the case where the adhesive energy between the adhesive member and the adherend is uniform.

As is apparent from the foregoing discussion, with regard to the distribution of the elastic modulus in a horizontal section of the adhesive member, such an adhesive member that the average elastic modulus of the half region on the first direction side and the average elastic modulus of the half region on the second direction side differ from each other is suitably used. To say in an additionally extended manner, the elastic modulus of the adhesive member is preferably nonuniformized so that the average elastic modulus of one of the two sections obtained by dividing the adhesive member along a direction vertical to the first direction and the average elastic modulus of the other section differ from each other. An adhesive member in which the ratio of the larger one of the average elastic moduli to the other is 5 or more is more suitably used. The elastic modulus desirably shows such distribution in the horizontal section of the entirety of the adhesive member, but the case where the elastic modulus shows such distribution only in the horizontal section of part of the member is also included in this embodiment.

The adhesive member whose elastic modulus or/and Poisson's ratio is/are nonuniformized can be produced by the following approach. For example, the elastic modulus or/and the Poisson's ratio is/are nonuniformized by physically modifying part of the adhesive member. More specifically, partial irradiation of an adhesive member produced from a uniform material with an electron or ion beam, or UV light modifies part of the adhesive member to provide an adhesive member whose elastic modulus or/and Poisson's ratio is/are nonuniformized. In addition, the elastic modulus or/and the Poisson's ratio is/are nonuniformized by sequentially producing adhesive members through the use of materials having different elastic moduli or/and different Poisson's ratios. More specifically, for example, a method involving bonding separately produced materials or a method involving producing the adhesive member in two steps through the use of a photothermal technology is available. Alternatively, the elastic modulus or/and the Poisson's ratio can also be nonuniformized by providing a degree of curing or a chemical bond state in an adhesive member formed of a polymer resin with a distribution. Further, for example, a method involving disposing objects having different elastic moduli or/and different Poisson's ratios toward one direction in the adhesive member is conceivable. The objects can be disposed toward one direction in the adhesive member by utilizing the sedimentation phenomena of the objects. It is sufficient to appropriately judge what kind of approach is suitable while taking, for example, specifications which the adhesive member is required to have into account.

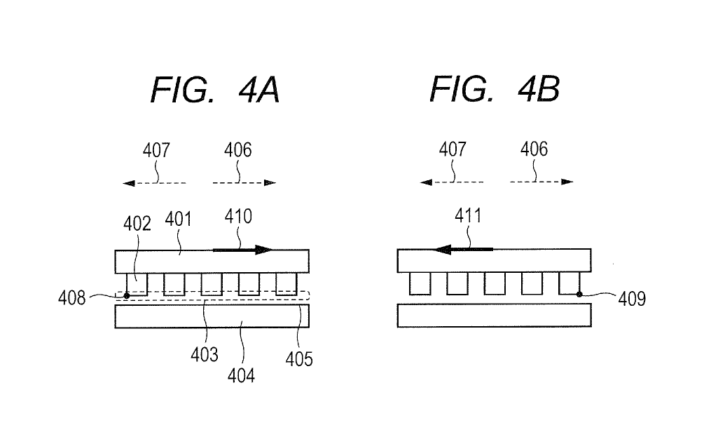

It is also suitable to adopt a construction in which the adhesive member includes a plurality of protruding portions configured to adhere to the adherend as illustrated in, for example, FIG. 4A and FIG. 4B. That is, the following mode is preferred: the adhesive member includes a plurality of protruding portions (402) configured to adhere to the adherend and a substrate portion (401) configured to support the protruding portions, and the nonuniformization of the elastic modulus or/and Poisson's ratio of the member is performed in at least the substrate portion. In this case, the adhesive surface (403) of the adhesive member is considered to be a surface obtained by assembling the individual adhesive surfaces of the individual protruding portions. In addition, a first peeling site (408) and a second peeling site (409) may be considered to be present not in the substrate portion but in the protruding portions. The substrate portion and the protruding portions can be constituted as separate bodies in all embodiments and reference examples including the protruding portions described in this specification, but the substrate portion and the protruding portions can be constituted as an integrated product as well. In such mode, rigidity near the adhesive surface of the adhesive member reduces, and hence its followability to the surface roughness of the adherend improves and the adhesive member can be expected to adhere to various adherends like a gecko. In addition, from the viewpoint of a material whose adhesive force has directional dependency, this embodiment has the following merit: the elastic modulus or/and Poisson's ratio of the substrate portion is/are nonuniformized, and hence the adhesive member is simply produced as compared to an adhesive material of a related-art example including numberless inclined columnar structural products.

A strain energy release rate in the adhesive member including the plurality of protruding portions and the substrate portion can be determined by structural analysis in a structure reflecting all shapes. However, in the case of an adhesive member, in which the sizes of the protruding portions are extremely small as compared to that of the substrate portion, or of an adhesive member having an extremely large number of protruding portions, the structural analysis reflecting all shapes may be difficult in terms of a calculation cost. In this case, it is suitable to determine the strain energy release rate through, for example, a multiscale simulation. That is, the following procedure is preferably adopted: first, a stress distribution in the substrate portion is determined by performing structural analysis in the substrate portion alone, and the structural analysis of the protruding portions is performed under a boundary condition reflecting the stress distribution. The protruding portions are suitably substantially columnar elastic body structural products, more suitably microvillus-like elastic body structural products each having a high aspect ratio. Thus, the rigidity of each of the protruding portions largely reduces and hence an additionally high adhesive force is realized.

The protruding portions can be directly fabricated by, for example, any one of the various technologies including a 3D printer, photolithography processes, self-organizing formation of structures, such as crystal growth, and machining technologies, such as shaving. An approach involving molding a polymer resin with a mold produced by any such direct fabricating technology is also extremely efficient in terms of mass production.

As a reference example, an adhesive member whose adhesive force has directional dependency can be provided by asymmetrizing a horizontal sectional shape of the adhesive member as well. The adhesive member of this reference example is an adhesive member configured to adhere to an adherend through an intersurface force. In addition, a strain energy release rate at the first peeling site of the adhesive member and an adhesive energy at the first peeling site in the case where a force is applied in a first direction parallel to the adhesive surface of the adhesive member are defined as G1^{b} and Δγ1^{b}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{b} and Δγ2^{b}, respectively. In this case, a horizontal section obtained by cutting the adhesive member parallel to the adhesive surface has an asymmetrized shape so that G1^{b}/Δγ1^{b}≠G2^{b}/Δγ2^{b} is satisfied.

As described in the foregoing, adhesive forces in the first direction and the second direction are determined to be F(G1^{b}/Δγ1^{b})^{-1/2} and F (G2^{b}/Δγ2^{b})^{-1/2}, respectively. Accordingly, in this reference example, such directional dependency of the adhesive force that the adhesive forces in the first direction and the second direction differ from each other is realized by asymmetrizing the horizontal sectional shape of the adhesive member so that G1^{b}/Δγ1^{b}≠G2^{b}/Δγ2^{b} is satisfied. The horizontal sectional shape obtained by cutting the adhesive member along a plane parallel (horizontal) to the adhesive surface is suitably a shape that is not point-symmetric or a shape that is not linearly symmetric with respect to an axis perpendicular to the first direction. In addition, the horizontal sectional shape is desirably asymmetrized over the entirety of the adhesive member, but the case where the horizontal sectional shape is asymmetrized only in part of the adhesive member is also included in this reference example.

As described in the foregoing, the strain energy release rates and the adhesive energies can be estimated or measured. Accordingly, a person skilled in the art can easily design the horizontal sectional shape so that G1^{b}/Δγ1^{b}≠G2^{b}/Δγ2^{b} is satisfied, and hence the directional dependency appears in the adhesive force as described in the foregoing. As a difference between the G1^{b}/Δγ1^{b} and the G2^{b}/Δγ2^{b} enlarges, the directional dependency of the adhesive member enlarges. Accordingly, for example, an adhesive member in which the ratio of the larger one of the G1^{b}/Δγ1^{b} and the G2^{b}/Δγ2^{b} to the other is 2 or more is suitably used, and an adhesive member in which the ratio is 5 or more is more suitably used.

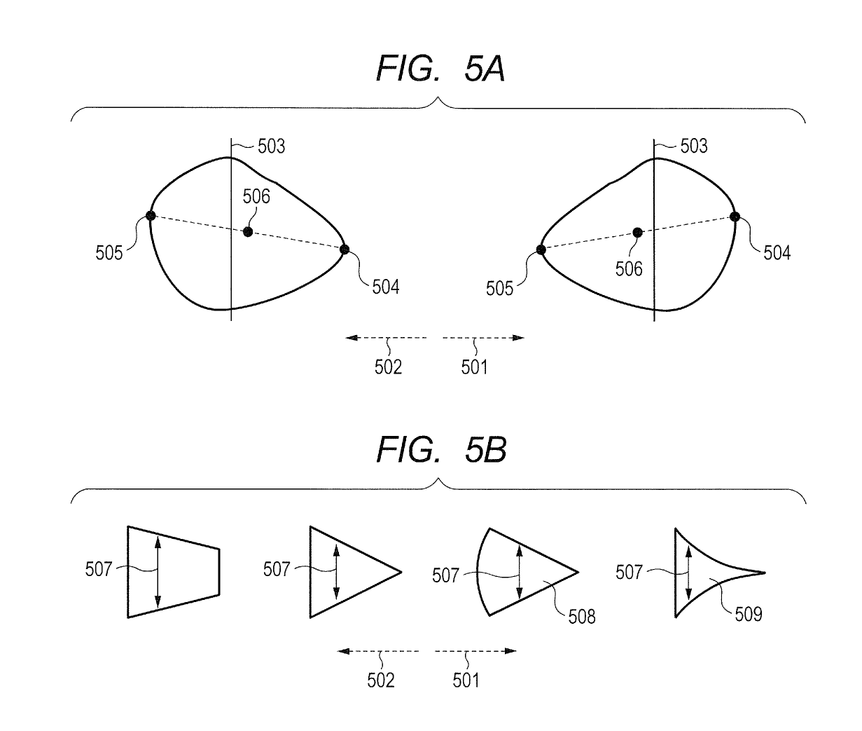

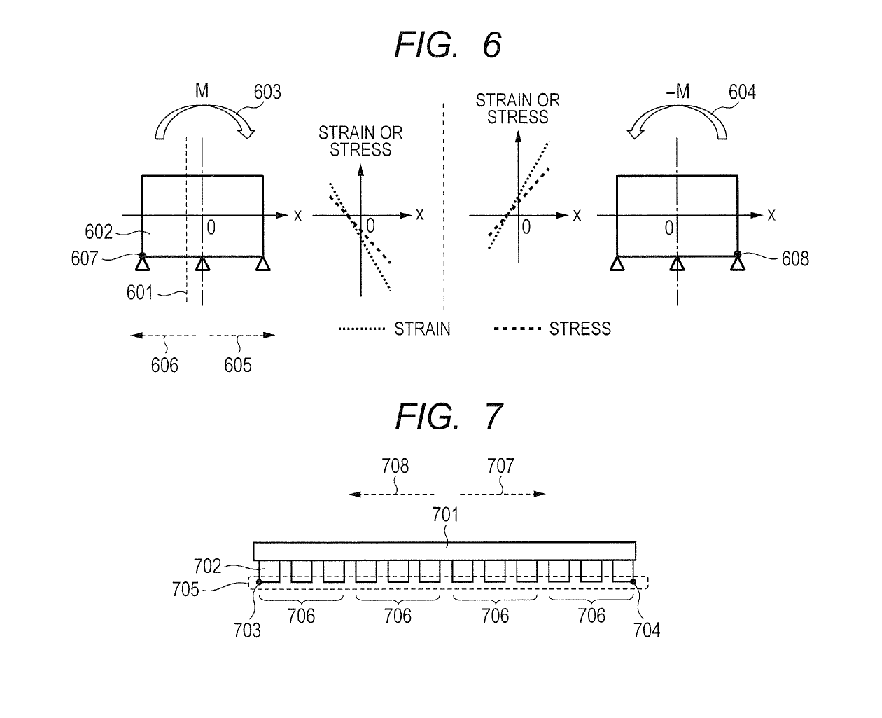

It is because of the following reason that the directional dependency appears in the adhesive force through the asymmetrization of the horizontal sectional shape: as illustrated in FIG. 5A, the position of an axis (503) which is perpendicular to a first direction (501) and along which the statical moment of the horizontal sectional shape becomes zero shifts from a center (506) of an end portion (504) of the horizontal section in the first direction and an end portion (505) thereof in the second direction. To simplify the description, on the assumption that the adhesive member is a structural product of a columnar shape having a uniform elastic modulus, a state in which the bottom surface (adhesive surface) of a columnar product (602) is fixed by being adhered to the adherend as illustrated in FIG. 6 is considered. FIG. 6 is an illustration of the columnar product when viewed from its side surface. In the case of the figure, a position (601) of the axis along which the statical moment becomes zero shifts to a second direction (606) side. The elastic modulus is assumed to be uniform, and hence the position of a neutral axis coincides with the position of the axis along which the statical moment becomes zero.

When a force is applied to the columnar product in a first direction (605) or the second direction (606), bending moments (603, 604) opposite in direction to each other are applied to the columnar product. When a stress distribution in the case where the bending moments (603, 604) are applied to the tip of the columnar product is considered, as illustrated in FIG. 6, the absolute value of a strain on the first direction side becomes larger than that on the second direction side. As a result, the absolute value of a stress on the first direction side also becomes larger than that on the second direction side. By virtue of the effect, a tensile stress generated at a second peeling site (608) by the bending moment (604) in which the first direction side becomes outside larger than a tensile stress generated at a first peeling site (607) by the bending moment (603) in which the second direction side becomes outside. Accordingly, G1^{b}/Δγ1^{b}<G2^{b}/Δγ2^{b} is satisfied, and hence such directional dependency that the adhesive force in the first direction becomes stronger than the other appears. When the position of the axis along which the statical moment becomes zero shifts to the first direction side, the directional dependency of the adhesive force is also reversed.

In the foregoing discussion, it has been assumed that the elastic modulus of the adhesive member is uniform in order that the position of the axis along which the statical moment becomes zero and the position of the neutral axis may be caused to coincide with each other. In addition, an adhesive energy between the adhesive member and the adherend has also been assumed to be uniform. However, it is apparent that even when the elastic modulus or the adhesive energy is nonuniform, proper asymmetrization of the horizontal sectional shape can change the position of the neutral axis to improve the directional dependency of the adhesive force. Accordingly, this reference example is not limited to the case where the elastic modulus or adhesive energy of the adhesive member is uniform. In addition, the shape of the adhesive member has been assumed to be a columnar shape having a uniform section, but the discussion can be qualitatively extended to adhesive members of other various shapes, and hence this reference example is not limited to the adhesive member of a columnar shape.

As is apparent from the foregoing discussion, as the shift of the position of the axis along which the statical moment of the horizontal sectional shape becomes zero enlarges, the directional dependency of the adhesive force improves. Accordingly, an adhesive member in which the magnitude of the shift is 5% or more of a distance between the end portion in the first direction and the end portion in the second direction is suitably used. Examples of such horizontal sectional shape that the axis along which the statical moment becomes zero largely shifts toward the second direction include such shapes as illustrated in FIG. 5B and shapes similar thereto. In each case, a width (507) of the horizontal sectional shape in a direction perpendicular to the first direction (501) increases toward a second direction (502) in a substantially monotonous manner, and hence the position of the axis along which the statical moment becomes zero effectively shifts to the second direction side. Here, the phrase “increases in a substantially monotonous manner” may include a site where the width of the horizontal sectional shape partially reduces, and for example, a fan sectional shape (508) also falls within the scope thereof. Such a sectional shape (509) that the width of the horizontal sectional shape increases in a substantially accelerating manner from the first direction toward the second direction is more suitably used.

The position of the axis along which the statical moment becomes zero desirably shifts to the same side over the entirety of the adhesive member, but the case where the position shifts only in part of the adhesive member is also included in this reference example. A construction in which the adhesive member includes a plurality of protruding portions configured to adhere to the adherend is also suitable. That is, the following mode is preferred: the adhesive member includes the plurality of protruding portions configured to adhere to the adherend and a substrate portion configured to support the protruding portions, and the asymmetrization of a horizontal section thereof is performed in at least the substrate portion. As described in the foregoing, in such mode, rigidity near the adhesive surface of the adhesive member reduces, and hence its followability to the surface roughness of the adherend improves and the adhesive member can be expected to adhere to various adherends like a gecko. In addition, from the viewpoint of a material whose adhesive force has directional dependency, this reference example has the following merit: the horizontal sectional shape of the substrate portion is asymmetrized, and hence the adhesive member is simply produced as compared to an adhesive material of a related-art example including numberless inclined columnar structural products. In addition, the protruding portions are suitably substantially columnar elastic body structural products, more suitably microvillus-like elastic body structural products each having a high aspect ratio. Thus, the rigidity of each of the protruding portions largely reduces and hence an additionally high adhesive force is realized.

As another reference example, an adhesive member whose adhesive force has directional dependency can be provided by nonuniformizing an adhesive energy between the adhesive member and an adherend as well. The adhesive member of this reference example is an adhesive member configured to adhere to the adherend through an intersurface force. In addition, a strain energy release rate at the first peeling site of the adhesive member and an adhesive energy at the first peeling site in the case where a force is applied in a first direction parallel to the adhesive surface of the adhesive member are defined as G1^{c} and Δγ1^{c}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{c} and Δγ2^{c}, respectively. In this case, the Δγ1^{c} and the Δγ2^{c} are caused to differ from each other so that G1^{c}/Δγ1^{c}≠G2^{c}/Δγ2^{c} is satisfied. As described in the foregoing, adhesive forces in the first direction and the second direction are determined to be F(G1^{c}/Δγ1^{c})^{-1/2} and F (G2^{c}/Δγ2^{c})^{-1/2}, respectively. Accordingly, in this reference example, such directional dependency of the adhesive force that the adhesive forces in the first direction and the second direction differ from each other is realized by causing the Δγ1^{c} and Δγ2^{c} to differ from each other so that G1^{c}/Δγ1^{c}≠G2^{c}/Δγ2^{c} is satisfied.

The strain energy release rates can be estimated by structural analysis or the like, and hence a person skilled in the art can easily design values for the adhesive energies Δγ1^{c} and Δγ2^{c} so that G1^{c}/Δγ1^{c}≠G2^{c}/Δγ2^{c} is satisfied. As a difference between the G1^{c}/Δγ1^{c} and the G2^{c}/Δγ2^{c} enlarges, the directional dependency of the adhesive member enlarges. Accordingly, for example, an adhesive member in which the ratio of the larger one of the G1^{c}/Δγ1^{c} and the G2^{c}/Δγ2^{c} to the other is 2 or more is suitably used, and an adhesive member in which the ratio is 5 or more is more suitably used. An adhesive member in which a difference between the Δγ1^{c} and the Δγ2^{c} is large is suitably used, and the ratio of the larger one of the Δγ1^{c} and the Δγ2^{c} to the other is desirably 2 or more, more desirably 5 or more.

When the intersurface force is an interaction force based on an intermolecular force, the adhesive energies Δγ1^{c} and Δγ2^{c} can each be determined by, for example, contact angle measurement, a molecular dynamics simulation, or a JKR test. Even when the intersurface force is an interaction force except the intermolecular force, the adhesive energies can each be determined by: determining the amount of work needed for separating the surfaces between which the intersurface force acts from an adhered state to an infinite distance; and converting the amount of work into a value per unit adhesion area. The adhesive energies are each a physical quantity defined as an interaction energy between the adhesive member and the adherend on the adhesive surface, and hence the Δγ1^{c} and the Δγ2^{c} can be caused to differ from each other by changing the surface state of the adherend instead of the surface state of the adhesive member.

In addition, the directional dependency of the adhesive force can be realized by changing the surface roughness of the adhesive member or the adherend to cause the first peeling site and the second peeling site to differ from each other in state of contact between the adhesive member and the adherend. The change of the state of contact through the surface roughness can be considered to be the arrangement of a void whose adhesive energy can be regarded as zero in an adhesive portion between the adhesive member and the adherend. In other words, an apparent average adhesive energy is reduced by increasing the surface roughness. Accordingly, such an adhesive member that the directional dependency of the adhesive force is realized by nonuniformizing the surface roughness of the adhesive member or the adherend is also included in this reference example. A suitable reference example is an adhesive member in which the G1^{c}, the G2^{c}, the Δγ1^{c}, and the Δγ2^{c} satisfy G1^{c}<G2^{c} and Δγ1^{c}>Δγ2^{c}, or satisfy G1^{c}>G2^{c} and Δγ1^{c}<Δγ2^{c}.

The reason for the foregoing is as described below. When G1^{c}/Δγ1^{c}<G2^{c}/Δγ2^{c} is satisfied, the adhesive force in the first direction is stronger than the other, and when G1^{c}/Δγ1^{c}>G2^{c}/Δγ2^{c} is satisfied, the adhesive force in the second direction is stronger than the other. Accordingly, when G1^{c}<G2^{c} and Δγ1^{c}>Δγ2^{c} are satisfied, effects based on a strain energy depending on the bulk physical properties and shapes of the adhesive member and the adherend, and an adhesive energy depending on their surface physical properties strengthen each other, and hence such directional dependency of the adhesive force that the adhesive force in the first direction is stronger than the other additionally improves. In addition, in contrast, when G1^{c}>G2^{c} and Δγ1^{c}<Δγ2^{c} are satisfied, such directional dependency of the adhesive force that the adhesive force in the second direction is stronger than the other additionally improves.

In addition, the range in which the values for the adhesive energies can each be changed has an upper limit and a lower limit owing to the restrictions of, for example, a production process for the adhesive member in many cases. In any such case, it is more desirable to set the adhesive energies at the first peeling site and the second peeling site as described below. When G1^{c}>G2^{c} is satisfied, it is most effective to set the adhesive energy at the first peeling site to the lower limit and to set the adhesive energy at the second peeling site to the upper limit. In addition, when G1^{c}<G2^{c} is satisfied, it is most effective to set the adhesive energy at the first peeling site to the upper limit and to set the adhesive energy at the second peeling site to the lower limit. When G1^{c}=G2^{c} is satisfied, it is most effective to set one of the adhesive energies at the first peeling site and the second peeling site to the lower limit, and to set the other adhesive energy to the upper limit.

Accordingly, in summary, a suitable reference example is such an adhesive member that G1^{c}≧G2^{c} is satisfied, and an adhesive energy Δγ^{c} at an arbitrary place on its adhesive surface satisfies Δγ1^{c}≦Δγ^{c} or/and Δγ2^{c}≧Δγ^{c}. Another suitable reference example is such an adhesive member that G1^{c}≦G2^{c} is satisfied, and the adhesive energy Δγ^{c} at an arbitrary place on its adhesive surface satisfies Δγ1^{c}Δγ^{c} or/and Δγ2^{c}≦Δγ^{c}.

In addition, another suitable reference example is such an adhesive member that its adhesive surface is formed of a plurality of regions having a substantially uniform adhesive energy, the adhesive energy of a region including a first peeling site is Δγ1^{c}, and the adhesive energy of a region including a second peeling site is Δγ2^{c}. The mode has the following advantage: a production process for the control of the surface states of the adhesive member and the adherend becomes easy, or a design process for the identification of the first peeling site and the second peeling site through structural analysis or the like becomes easy. From the viewpoint of the ease of each of the production process and the design process, the number of the regions is desirably as small as possible, and a construction formed of two regions is the best.

An approach involving nonuniformizing the adhesive energy between the adhesive member and the adherend to cause the Δγ1^{c} and the Δγ2^{c} to differ from each other is, for example, the following approach. When the adhesive member and the adherend each produced from a uniform material are partially irradiated with an electron or ion beam, UV light, or plasma while the amount of energy of the beam, the light, or the plasma is controlled, part of the adhesive surface of the adhesive member and the surface of the adherend are modified, and hence the adhesive energy can be nonuniformized. New atomic and molecular layers can be partially arranged on the adhesive surface of the adhesive member and the surface of the adherend by various physical and chemical processes.

In addition, in the description of the embodiment in which the elastic modulus or/and the Poisson's ratio is/are nonuniformized, an approach to producing an adhesive member formed of a plurality of kinds of materials has been given as an example, and the approach is also useful as an approach to nonuniformizing the adhesive energy between the adhesive member and the adherend. A possible approach involving changing the surface roughness of each of the first peeling site and the second peeling site to cause the apparent Δγ1^{c} and the apparent Δγ2^{c} to differ from each other is an approach involving partially processing the adhesive surface of the adhesive member and the surface of the adherend by means of, for example, light, an electron beam, an ion beam, or machining. It is sufficient to appropriately judge what kind of approach is suitable while taking, for example, specifications which the adhesive member is required to have into account.

In addition, as described in the foregoing, it is also suitable to adopt a construction in which the adhesive member includes a plurality of protruding portions configured to adhere to the adherend. That is, the following mode is preferred: the adhesive member includes the plurality of protruding portions configured to adhere to the adherend and a substrate portion configured to support the protruding portions, and an adhesive energy between each of the protruding portions and the adherend is nonuniformized. In such mode, rigidity near the adhesive surface of the adhesive member reduces, and hence its followability to the surface roughness of the adherend improves and the adhesive member can be expected to adhere to various adherends like a gecko. In addition, from the viewpoint of a material whose adhesive force has directional dependency, this reference example has the following merit: the adhesive member is simply produced as compared to an adhesive material of a related-art example including numberless inclined columnar structural products. In addition, the protruding portions are suitably substantially columnar elastic body structural products, more suitably microvillus-like elastic body structural products each having a high aspect ratio. Thus, the rigidity of each of the protruding portions largely reduces and hence an additionally high adhesive force is realized. In the case of the adhesive member including the plurality of protruding portions configured to adhere to the adherend, as described in the foregoing, the first peeling site and the second peeling site may be considered to be present not in the substrate portion but in the protruding portions. Accordingly, the Δγ1^{c} and the Δγ2^{c} refer to adhesive energies between each of the protruding portions and the adherend at which the peeling of the member occurs when forces are applied in the respective directions.

The construction including the plurality of protruding portions configured to adhere to the adherend can be adopted for each of the following adhesive members described in the foregoing: the adhesive member satisfying G1^{c}<G2^{c} and Δγ1^{c}>Δγ2^{c}; the adhesive member satisfying G1^{c}>G2^{c} and Δγ1^{c}<Δγ2^{c}; such adhesive member that G1^{c}≧G2^{c} is satisfied, and the adhesive energy Δγ^{c} at an arbitrary place on its adhesive surface satisfies Δγ1^{c}≦Δγ^{c} or/and Δγ2^{c}≧Δγ^{c}; and such adhesive member that G1^{c}≦G2^{c} is satisfied, and the adhesive energy Δγ^{c} at an arbitrary place on its adhesive surface satisfies Δγ1^{c}≧Δγ^{c} or/and Δγ2^{c}≦Δγ^{c}. As described in the foregoing, the adhesive surface of the adhesive member is a surface obtained by assembling the individual adhesive surfaces of the individual protruding portions. Accordingly, the arbitrary place on the adhesive surface is interpreted as an arbitrary place in the adhesive surface of an arbitrary protruding portion.

In addition, the construction having the plurality of protruding portions can be adopted for such adhesive member that its adhesive surface is formed of the plurality of regions having a substantially uniform adhesive energy, the adhesive energy of the region including the first peeling site is Δγ1^{c}, and the adhesive energy of the region including the second peeling site is Δγ2^{c}. For example, a construction illustrated in FIG. 7 is adopted. As described in the foregoing, an adhesive surface (705) of the adhesive member is a surface obtained by assembling the individual adhesive surfaces of individual protruding portions (702), and hence the surface obtained by assembling the individual adhesive surfaces is interpreted as being formed of a plurality of regions (706) having a substantially uniform adhesive energy. Further, the adhesive energy of the region including the first peeling site is defined as Δγ1^{c}, and the adhesive energy of the region including the second peeling site is defined as Δγ2^{c}. The mode has the following advantage: a production process for the control of the surface states of the adhesive member and the adherend becomes easy, or a design process for the identification of the first peeling site and the second peeling site through structural analysis or the like becomes easy. From the viewpoint of the ease of each of the production process and the design process, the number of the regions is desirably as small as possible, and a construction formed of two regions is the best.

The directional dependency of the adhesive force can be additionally improved by properly combining the nonuniformization of the elastic modulus or/and Poisson's ratio of the adhesive member with each of:the asymmetrization of the horizontal sectional shape of the adhesive member; and the nonuniformization of the adhesive energy between the adhesive member and the adherend. In addition, it has been known that the directional dependency of the adhesive force can be realized by turning a vertical sectional shape of the adhesive member into a shape that is not bilaterally symmetric like an inclined columnar shape, and the directional dependency of the adhesive force can be improved by selecting proper combination.

Here, a strain energy release rate at the first peeling site of the adhesive member and an adhesive energy at the first peeling site are represented by G1 and Δγ1, respectively, and a strain energy release rate at the second peeling site thereof and an adhesive energy at the second peeling site are represented by G2 and Δγ2, respectively. Thus, as described in the foregoing, adhesive forces in the first direction and the second direction are determined to be F(G1/Δγ1)^{-1/2} and F(G2/Δγ2)^{-1/2}, respectively. Here, when the strength of the directional dependency of the adhesive force is represented by R=(adhesive force in the second direction)/(adhesive force in the first direction), R=(G1Δγ2/G2Δγ1)^{1/2} is obtained. In the range of R<1, i.e., G1Δγ2/G2Δγ1<1, the adhesive force in the first direction is stronger than the other, and as a value for the G1Δγ2/G2Δγ1 becomes smaller, the directional dependency of the adhesive force improves. In addition, in contrast, in the range of R>1, i.e., G1Δγ2/G2Δγ1>1, the adhesive force in the second direction is stronger than the other, and as the value for the G1Δγ2/G2Δγ1 becomes larger, the directional dependency of the adhesive force improves.

Accordingly, when the nonuniformization of the elastic modulus or/and the Poisson's ratio is combined with a characteristic, such as the asymmetrization of the horizontal sectional shape, the nonuniformization of the adhesive energy, or the asymmetrization of the vertical sectional shape, the directional dependency of the adhesive force can be improved as described below. That is, the directional dependency of the adhesive force can be additionally improved by properly designing the G1Δγ2/G2Δγ1 so that the G1Δγ2/G2Δγ1 becomes additionally small under the condition of G1Δγ2/G2Δγ1<1, or becomes additionally large under the condition of G1Δγ2/G2Δγ1>1.

As an embodiment of the present invention, the nonuniformization of the elastic modulus or/and the Poisson's ratio, and the asymmetrization of the horizontal sectional shape can be combined with each other. An adhesive member in this embodiment is an adhesive member configured to adhere to an adherend through an intersurface force, its elastic modulus or/and Poisson's ratio is/are nonuniformized, and a horizontal section obtained by cutting the adhesive member along a plane parallel to its adhesive surface has an asymmetrized shape. Further, the following condition is satisfied. A strain energy release rate at the first peeling site of the adhesive member and an adhesive energy at the first peeling site in the case where a force is applied in a first direction parallel to the adhesive surface are defined as G1^{a,b} and Δγ1^{a,b}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{a,b} and Δγ2^{a,b,} respectively. Then, G1^{a,b}/Δγ1^{a,b}≠G2^{a,b}/Δγ2^{a,b} is satisfied.

In addition, further, the strain energy release rate G1^{a, b}, the adhesive energy Δγ1^{a,b}, the strain energy release rate G2^{a,b}, and the adhesive energy Δγ2^{a,b} are represented as described below. That is, those values are represented by G1^{a-,b}, G2^{a-,b}, Δγ1^{a-,b}, G2^{a-,b}, and Δγ2^{a-,b}, respectively in the case where the elastic modulus and Poisson's ratio of the adhesive member are assumed to be uniform. In this case, G1^{a,b}Δγ2^{a,b}/G2^{a,b}Δγ1^{a,b}<G1^{a-,b}Δγ2^{a-,b}/G2^{a-,b}Δγ1^{a-,b}<1 or G1^{a,b}Δγ2^{a,b}/G2^{a,b}Δγ1^{a,b}>G1^{a-,b}Δγ2^{a-,b}/G2^{a-,b}Δγ1^{a-,b}>1 is satisfied. Here, those values in the case where the elastic modulus and Poisson's ratio of the adhesive member are assumed to be uniform refer to values obtained by averaging the nonuniform elastic moduli or/and nonuniform Poisson's ratios of the adhesive member. In addition, the case where the elastic modulus and Poisson's ratio of the adhesive member are assumed to be uniform refers to the case where all characteristics of the adhesive member except the elastic modulus and the Poisson's ratio are identical, and the elastic modulus and Poisson's ratio of the entirety of the adhesive member are the averaged values. In the case where G1^{a-,b}Δγ2^{a-,b}/G2^{a-,b}Δγ1^{a-,b}<1 is satisfied, even when the elastic modulus and the Poisson's ratio have uniform values, the adhesive member shows such directional dependency that an adhesive force in the first direction becomes stronger than an adhesive force in the second direction. In addition, the directional dependency of the adhesive force can be additionally improved by additionally nonuniformizing the elastic modulus or/and the Poisson's ratio so that G1^{a,b}Δγ2^{a,b}/G2^{a,b}Δγ1^{a,b}<G1^{a-,b}Δγ2^{a-,b}/G2^{a-,b}Δγ1^{a-,b}<1 is satisfied.

In addition, similarly, in the case where G1^{a-,b}Δγ2^{a-,b}/G2^{a-,b}Δγ1^{a-,b}>1 is satisfied, even when the elastic modulus and the Poisson's ratio have uniform values, the adhesive member shows such directional dependency that the adhesive force in the second direction becomes stronger than the adhesive force in the first direction. In addition, the directional dependency of the adhesive force can be additionally improved by additionally nonuniformizing the elastic modulus or/and the Poisson's ratio so that G1^{a,b}Δγ2^{a,b}/G2^{a,b}Δγ1^{a,b}>G1^{a-,b}Δγ2^{a-,b}/G2^{a-,b}Δγ1^{a-,b}>1 is satisfied.

In other words, according to the construction, the effect of the nonuniformization of the elastic modulus or/and Poisson's ratio of the adhesive member, and the effect of the asymmetrization of the horizontal sectional shape of the adhesive member strengthen each other, and hence additionally high directional dependency of the adhesive force is exhibited. As described in the foregoing, the G1^{a,b}Δγ2^{a,b}/G2^{a,b}Δγ1^{a,b} and the G1^{a-,b}Δγ2^{a-,b}/G2^{a-,b}Δγ1^{a-,b} can be determined by combining measurements based on structural analysis and an experiment, and hence a person skilled in the art can easily design the adhesive member in this embodiment. The foregoing holds true for all the following combination examples.

In addition, as another embodiment of the present invention, the nonuniformization of the elastic modulus or/and the Poisson's ratio, and the nonuniformization of the adhesive energy can be combined with each other. An adhesive member in this embodiment is an adhesive member configured to adhere to an adherend through an intersurface force, and its elastic modulus or/and Poisson's ratio is/are nonuniformized. Further, the following conditions are satisfied. A strain energy release rate at the first peeling site of the adhesive member and an adhesive energy at the first peeling site in the case where a force is applied in a first direction parallel to the adhesive surface of the adhesive member are defined as G1^{a,c} and Δγ1^{a,c}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{a,c} and Δγ2^{a,c}, respectively. Then, the Δγ1^{a,c} and the Δγ2^{a,c} differ from each other, and G1^{a,c}/Δγ1^{a,c}≠G2^{a,c}/Δγ2^{a,c} is satisfied.

In addition, further, the strain energy release rate G1^{a,c}, the adhesive energy Δγ1^{a,c}, the strain energy release rate G2^{a,c}, and the adhesive energy Δγ2^{a,c} are represented as described below in the case where the elastic modulus and Poisson's ratio of the adhesive member are assumed to be uniform. That is, those values are represented by G1^{a-,c}, Δγ1^{a-,c}, G2^{a-,c} and Δγ2^{a-,c}, respectively. In this case, G1^{a,c}Δγ2^{a,c}/G2^{a,c}Δγ1^{a,c}<G1^{a-,c}Δγ2^{a-,c}/G2^{a-,c}Δγ1^{a-,c}<1 or G1^{a,c}Δγ2^{a,c}/G2^{a,c}Δγ1^{a,c}>G1^{a-,c}Δγ2^{a-,c}/G2^{a-,c}Δγ1^{a-,c}>1 is satisfied. According to the construction, the effect of the nonuniformization of the elastic modulus or/and Poisson's ratio of the adhesive member, and the effect of causing the adhesive energies between the adhesive member and the adherend to differ from each other strengthen each other, and hence additionally high directional dependency of the adhesive force is exhibited.

In addition, as another embodiment of the present invention, the nonuniformization of the elastic modulus or/and the Poisson's ratio, and the asymmetrization of the vertical sectional shape can be combined with each other. That is, the nonuniformization is combined with the case where a section (vertical sectional shape) obtained by cutting the adhesive member along a surface vertical to its adhesive surface and parallel to the first direction has a bilaterally asymmetrized shape. An adhesive member in this embodiment is an adhesive member configured to adhere to an adherend through an intersurface force, its elastic modulus or/and Poisson's ratio is/are nonuniformized, and a vertical section obtained by cutting the adhesive member along a surface vertical to its adhesive surface and parallel to a first direction has a bilaterally asymmetrized shape. Further, the following condition is satisfied. A strain energy release rate at the first peeling site of the adhesive member and an adhesive energy at the first peeling site in the case where a force is applied in the first direction parallel to the adhesive surface are defined as G1^{a,d} and Δγ1^{a,d}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{a,d} and Δγ2^{a,d}, respectively. Then, G1^{a,d}/Δγ1^{a,d}≠G2^{a,d}/Δγ2^{a,d} is satisfied.

In addition, further, the strain energy release rate G1^{a,d}, the adhesive energy Δγ1^{a,d}, the strain energy release rate G2^{a,d}, and the adhesive energy Δγ2^{a,d} are represented as described below. That is, those values are represented by G1^{a-,d}, Δγ1^{a-,d}, G2^{a-,d} and Δγ2^{a-,d}, respectively in the case where the elastic modulus and Poisson's ratio of the adhesive member are assumed to be uniform. In this case, G1^{a,d}Δγ2^{a,d}/G2^{a,d}Δγ1^{a,d}<G1^{a-,d}Δγ2^{a-,d}/G2^{a-,d}Δγ1^{a-,d}<1 or G1^{a,d}Δγ2^{a,d}/G2^{a,d}Δγ1^{a,d}>G1^{a-,d}Δγ2^{a-,d}/G2^{a-,d}Δγ1^{a-,d}>1 is satisfied. According to the construction, the effect of the nonuniformization of the elastic modulus or/and Poisson's ratio of the adhesive member, and the effect of the asymmetrization of the vertical sectional shape of the adhesive member strengthen each other, and hence additionally high directional dependency of the adhesive force is exhibited.

In addition, as a reference example, the asymmetrization of the horizontal sectional shape and the nonuniformization of the adhesive energy can be combined with each other. An adhesive member in this reference example is an adhesive member configured to adhere to an adherend through an intersurface force, and a horizontal section obtained by cutting the adhesive member along a plane parallel to its adhesive surface has an asymmetrized shape. Further, the following conditions are satisfied. That is, a strain energy release rate at the first peeling site of the adhesive member and an adhesive energy at the first peeling site in the case where a force is applied in a first direction parallel to the adhesive surface are defined as G1^{b,c} and Δγ1^{b,c}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{b,c} and Δγ2^{b,c}, respectively. In this case, the Δγ1^{b,c} and the Δγ2^{b,c} differ from each other, and G1^{b,c}/Δγ1^{b,c}≠G2^{b,c}/Δγ2^{b,c} is satisfied.

In addition, further, the strain energy release rate G1^{b,c}, the adhesive energy Δγ1^{b,c}, the strain energy release rate G2^{b,c}, and the adhesive energy Δγ2^{b,c} are represented as described below. That is, those values are represented by G1^{b,c}, Δγ1^{b,c-}, G2^{b,c-}, and Δγ2^{b,c-}, respectively in the case where the Δγ1^{b,c} and the Δγ2^{b,c} are assumed to be equal to each other. In this case, G1^{b,c}Δγ2^{b,c}/G2^{b,c}Δγ1^{b,c}<G1^{b,c-}Δγ2^{b,c-}/G2^{b,c-}Δγ1^{b,c-}<1 or G1^{b,c}Δγ2^{b,c}/G2^{b,c}Δγ1^{b,c}>G1^{b,c-}Δγ2^{b,c-}/G2^{b,c-}Δγ1^{b,c-}>1 is satisfied.

Here, the case where the Δγ1^{b,c} and the Δγ2^{b,c} are assumed to be equal to each other is predicated on the case where all requirements of the adhesive member except the adhesive energies are identical. The G1^{b,c-}Δγ2^{b,c-}/G2^{b,c-}Δγ1^{b,c-}in this case can also be determined by combining measurements based on structural analysis and an experiment. According to the construction, the effect of the asymmetrization of the horizontal sectional shape of the adhesive member, and the effect of causing the adhesive energies between the adhesive member and the adherend to differ from each other strengthen each other, and hence additionally high directional dependency of the adhesive force is exhibited.

In addition, as another reference example, the asymmetrization of the horizontal sectional shape and the asymmetrization of the vertical sectional shape can be combined with each other. An adhesive member in this reference example is an adhesive member configured to adhere to an adherend through an intersurface force, and a horizontal section obtained by cutting the adhesive member along a plane parallel to its adhesive surface has an asymmetrized shape. In addition, a vertical section obtained by cutting the adhesive member along a surface vertical to the adhesive surface and parallel to a first direction has a bilaterally asymmetrized shape.

In addition, the following condition is satisfied. A strain energy release rate at the first peeling site of the adhesive member and an adhesive energy at the first peeling site in the case where a force is applied in the first direction parallel to the adhesive surface are defined as G1^{b,d} and Δγ1^{b,d}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{b,d} and Δγ2^{b,d}, respectively. In this case, G1^{b,d}/Δγ1^{b,d}≠G2^{b,d}/Δγ2^{b,d} is satisfied.

In addition, further, the strain energy release rate G1^{b,d}, the adhesive energy Δγ1^{b,d}, the strain energy release rate G2^{b,d}, and the adhesive energy Δγ2^{b,d} are represented as described below. That is, those values are represented by G1^{b,d-}, Δγ1^{b,d-}, G2^{b,d-} and Δγ2^{b,d-}, respectively in the case where a section obtained by cutting the adhesive member along a surface vertical to the adhesive surface and parallel to the first direction is assumed to have a bilaterally symmetric shape. In this case, G1^{b,d}Δγ2^{b,d}/G2^{b,d}Δγ1^{b,d}<G1^{b,d-}Δγ2^{b,d-}/G2^{b,d-}Δγ1^{b,d-}<1 or G1^{b,d}Δγ2^{b,d}/G2^{b,d}Δγ1^{b,d}>G1^{b,d-}Δγ2^{b,d-}/G2^{b,d-}Δγ1^{b,d-}>1 is satisfied.

Here, the case where the section obtained by cutting the adhesive member along the surface vertical to the adhesive surface and parallel to the first direction is assumed to have a bilaterally symmetric shape is as described below. First, the adhesive member is considered to be a stack of fragments obtained by slicing the member in the direction parallel to the adhesive surface in an infinitely thin manner. Then, the respective fragments are moved parallel to the adhesive surface to be stacked again so that the section obtained by cutting the adhesive member along the surface vertical to the adhesive surface and parallel to the first direction is bilaterally symmetric. A virtual adhesive member thus produced is defined as the case where the section is assumed to have a bilaterally symmetric shape.

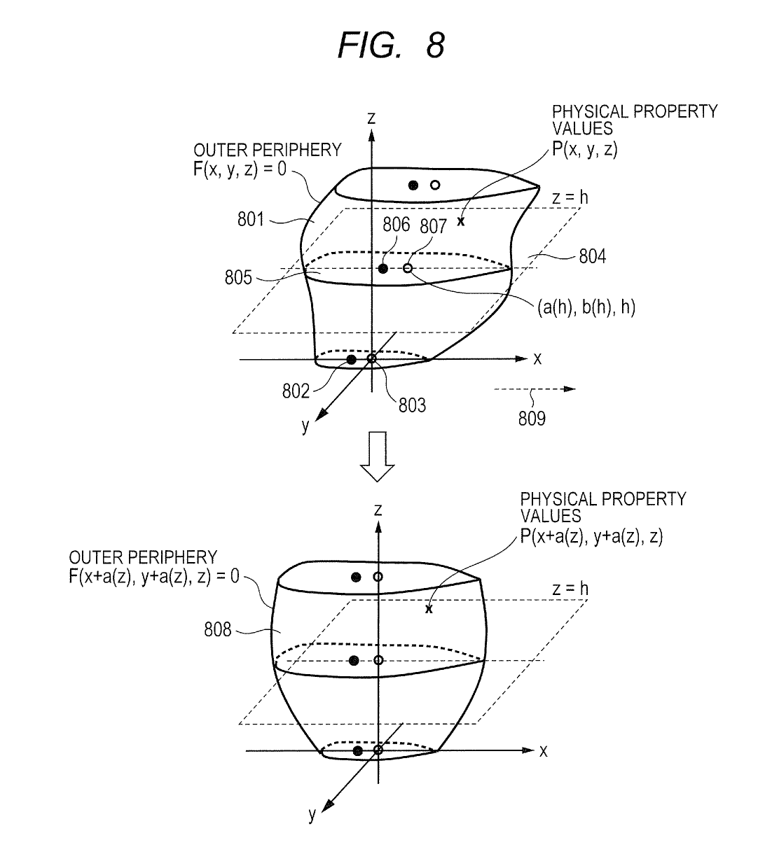

An additionally detailed procedure is described with reference to FIG. 8. A straight line passing a centroid (802) of the adhesive surface of an adhesive member (801) and parallel to a first direction (809) is drawn, and a middle point (803) of the two points of intersection of the straight line and the outer periphery of the adhesive surface of the adhesive member is obtained. The middle point is defined as an origin, and an x-axis directed toward the first direction, a z-axis directed toward the direction vertical to the adhesive surface of the adhesive member, and a y-axis perpendicular to both the x-axis and the z-axis are arranged. Thus, the outer periphery of the adhesive member can be represented by an equation F(x, y, z)=0, and vector quantities representing various physical property values of the adhesive member at coordinates (x, y, z) can be represented by P(x, y, z).

Next, a straight line passing a centroid (806) of a section (805) obtained by cutting the adhesive member along a plane (804) defined by z=h and parallel to the first direction is drawn, and the coordinates of a middle point (807) of the two points of intersection of the straight line and the outer periphery of the section are defined as (a(h), b(h), h). An adhesive member obtained by moving each section parallel to an xy-plane so that the middle point thus obtained is placed on the z-axis is defined as a virtual adhesive member (808). A section obtained by cutting the virtual adhesive member along a surface vertical to the adhesive surface of the adhesive member and parallel to the first direction has a bilaterally symmetric shape. Accordingly, the outer periphery of the virtual adhesive member in the case where the section is assumed to have a bilaterally symmetric shape can be defined by an equation F(x+a(z), y+b(z), z)=0. Further, when vector quantities representing various physical property values of the virtual adhesive member at the coordinates (x, y, z) are defined as P(x+a(z), y+b(z), z), the distribution of the physical property values can be maintained.

When the virtual adhesive member defined as described above is used, the G1^{b,d-}Δγ2^{b,d-}/G2^{b,d-}Δγ1^{b,d-} can also be determined by combining measurements based on structural analysis and an experiment. According to the construction, the effect of the asymmetrization of the horizontal sectional shape of the adhesive member and the effect of the asymmetrization of the vertical sectional shape of the adhesive member strengthen each other, and hence additionally high directional dependency of the adhesive force is exhibited.

In addition, as another reference example, the nonuniformization of the adhesive energy and the asymmetrization of the vertical sectional shape can be combined with each other. An adhesive member in this reference example is an adhesive member configured to adhere to an adherend through an intersurface force, and a vertical section obtained by cutting the adhesive member along a surface vertical to its adhesive surface and parallel to a first direction has a bilaterally asymmetrized shape. In addition, the following conditions are satisfied. A strain energy release rate at the first peeling site of the adhesive member and an adhesive energy at the first peeling site in the case where a force is applied in the first direction parallel to the adhesive surface are defined as G1^{c,d} and Δγ1^{c,d}, respectively. In addition, a strain energy release rate at the second peeling site of the adhesive member and an adhesive energy at the second peeling site in the case where a force having the same magnitude as that of the force applied in the first direction is applied in a second direction opposite to the first direction are defined as G2^{c,d} and Δγ2^{c,d}, respectively. In this case, the Δγ1^{c,d} and the Δγ2^{c,d} differ from each other, and G1^{c,d}/Δγ1^{c,d}≠G2^{c,d}/Δγ2^{c,d} is satisfied.

In addition, further, the strain energy release rate G1^{c,d}, the adhesive energy Δγ1^{c,d}, the strain energy release rate G2^{c,d}, and the adhesive energy Δγ2^{c,d} are represented as described below. That is, those values are represented by G1^{c-,d}, Δγ1^{c-,d}, G2^{c-,d}, and Δγ2^{c-,d}, respectively in the case where the Δγ1^{c,d} and the Δγ2^{c,d} are assumed to be equal to each other. In this case, G1^{c,d}Δγ2^{c,d}/G2^{c,d}Δγ1^{c,d}<G1^{c-,d}Δγ2^{c-,d}/G2^{c-,d}Δγ1^{c-,d}<1 or G1^{c,d}Δγ2^{c,d}/G2^{c,d}Δγ1^{c,d}>G1^{c-,d}Δγ2^{c-,d}/G2^{c-,d}Δγ1^{c-,d}>1 is satisfied.

According to the construction, the effect of causing the adhesive energies between the adhesive member and the adherend to differ from each other, and the effect of the asymmetrization of the vertical sectional shape of the adhesive member strengthen each other, and hence additionally high directional dependency of the adhesive force is exhibited.

Further, as another embodiment of the present invention, the nonuniformization of the elastic modulus or/and the Poisson's ratio can be combined with one or more characteristics out of the characteristics, i.e., the asymmetrization of the horizontal sectional shape, the nonuniformization of the adhesive energy, and the asymmetrization of the vertical sectional shape. When the nonuniformization is combined with one or more of the characteristics, the directional dependency of the adhesive force can be particularly improved by performing the combination while properly designing the G1Δγ2/G2Δγ1 so that the G1Δγ2/G2Δγ1 becomes additionally small under the condition of G1Δγ2/G2Δγ1<1, or becomes additionally large under the condition of G1Δγ2/G2Δγ1>1.

In addition, also when the plurality of characteristics are combined with each other, it is suitable to adopt a construction in which the adhesive member includes a plurality of protruding portions configured to adhere to the adherend. That is, the following mode is preferred: the adhesive member includes the plurality of protruding portions configured to adhere to the adherend and a substrate portion configured to support the protruding portions. In such mode, as described in the foregoing, rigidity near the adhesive surface of the adhesive member reduces, and hence its followability to the surface roughness of the adherend improves and the adhesive member can be expected to adhere to various adherends like a gecko. In addition, from the viewpoint of a material whose adhesive force has directional dependency, the following merit is obtained: the adhesive member is simply produced as compared to an adhesive material of a related-art example including numberless inclined columnar structural products. In addition, the protruding portions are suitably substantially columnar elastic body structural products, more suitably microvillus-like elastic body structural products each having a high aspect ratio. Thus, the rigidity of each of the protruding portions largely reduces and hence an additionally high adhesive force is realized.

The present invention is described in more detail below by way of specific Examples and Reference Examples.

### Example 1

Prior to the description of a construction example of an adhesive member, an example of a method of calculating a strain energy release rate through a simulation, and an example of a method of calculating an adhesion profile through a simulation are described.

<Calculation of Strain Energy Release Rate Through Simulation>

For example, a strain energy release rate at a peeling site of the adhesive member can be determined by the same approach as a virtual crack extension method in fracture mechanics (hereinafter referred to as “virtual peeling extension method”). The surface force and relative displacement of a virtual peeling portion to be used in the virtual peeling extension method are determined by, for example, structural analysis based on a boundary element method. Somigliana's boundary integral equation is used as an integral equation, and Rongved's solution serving as a fundamental solution for a two-phase conjugate is used as a fundamental solution. The use of the fundamental solution eliminates the need for the arrangement of a nodal point in an adhesion portion between the adhesive member and an adherend where a complex stress occurs, and hence enables the surface force and the relative displacement to be calculated with additionally high accuracy.

Here, to simplify the description, the adhesive member is assumed to have a shape symmetric with respect to a direction parallel to its adhesive surface and vertical to a first direction. In this case, the behavior of the adhesive member can be analyzed in a two-dimensional plane formed of the first direction and a direction vertical to the adhesive surface. Of course, the following approach can be easily extended to three dimensions.

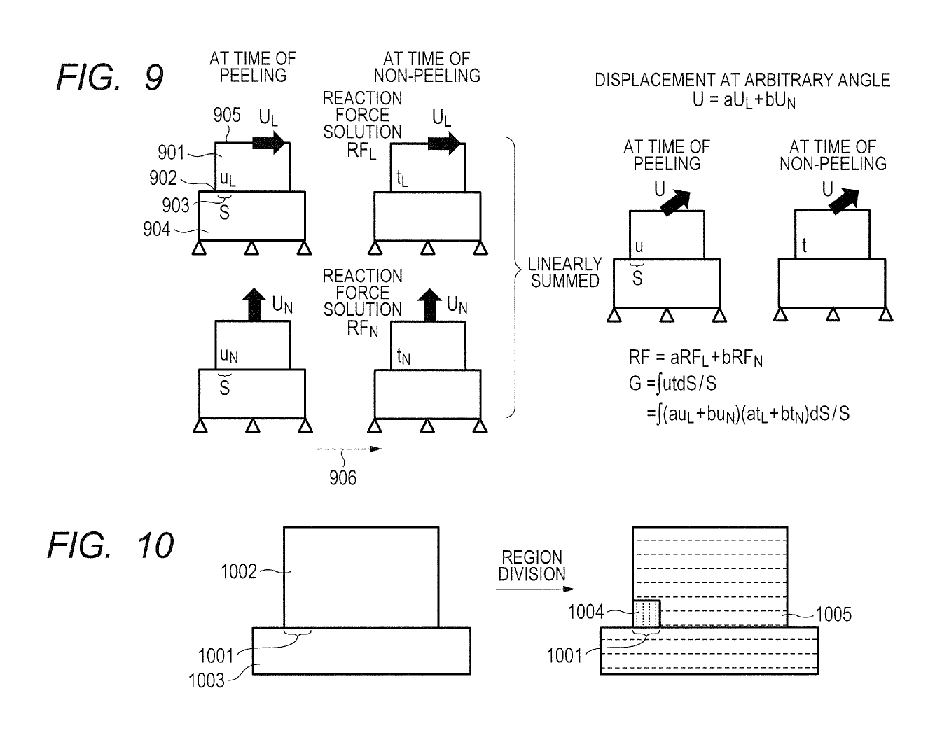

In order that a strain energy release rate at the first peeling site of the adhesive member in the case where a force is applied in the first direction may be calculated, a minute virtual peeling portion (903) is arranged at a first peeling site (902) of an adhesive member (901) as illustrated in FIG. 9. Performed first is structural analysis when a displacement vector U_{L} in a first direction (906) or a displacement vector U_{N} in a direction vertical to the adhesive surface of the adhesive member is applied to a nodal point on an upper surface (905) of the adhesive member in a state in which the adhesive surface except the virtual peeling portion adheres to an adherend (904) and the virtual peeling portion does not adhere (at the time of peeling). Thus, a relative displacement vector u_{L} or u_{N} between the adhesive surface of the adhesive member and the surface of the adherend to be generated in the virtual peeling portion by the displacement U_{L} or the displacement U_{N} is determined. Performed next is structural analysis when the displacement vector U_{L} or the displacement vector U_{N} is also applied to the nodal point on the upper surface of the adhesive member in a state in which the entirety of the adhesive surface of the adhesive member including the virtual peeling portion adheres to the adherend (at the time of non-peeling). Thus, a surface force vector t_{L} or t_{N} to be generated on the surface of the virtual peeling portion of the adhesive member by the displacement vector U_{L} or the displacement vector U_{N}, and a reaction force vector RF_{L} or a vector RF_{N} to be generated on the upper surface of the adhesive member by any such displacement vector are determined.

The foregoing results are linearly summed. Thus, a surface force vector t to be generated on the surface of the virtual peeling portion of the adhesive member by a displacement vector U=aU_{L}+bU_{N} in an arbitrary direction in the two-dimensional plane, a relative displacement vector u between the adhesive surface of the adhesive member and the surface of the adherend to be generated by the displacement vector, and a reaction force vector RF to be generated on the upper surface of the adhesive member by the displacement vector are represented as described below.

t=at_{L}+bt_{N}

u=au_{L}+bu_{N}

RF=aRF_{L}+bRF_{N}

A strain energy release rate G at the first peeling site for the force vector RF thus given is determined as described below. That is, the rate is determined as a function of a and b like the following equation by: integrating the inner product of the surface force vector t on the surface of the virtual peeling portion and the relative displacement vector u over the entirety of the virtual peeling portion; and dividing the resultant value by an area S of the virtual peeling portion.

G=∫(au_{L}+bu_{N})(at_{L}+bt_{N})dS/S

Accordingly, the strain energy release rate G1 when a force having a magnitude of F is applied in the first direction is determined by: determining values for a and b at which the magnitude of the component of the RF in the first direction is F and the magnitude of the component thereof in the direction vertical to the adhesive surface of the member is 0; and substituting the values into the equation. The strain energy release rate G2 at the second peeling site of the adhesive member in the case where a force is applied in a second direction can be similarly determined by arranging a virtual peeling portion at the second peeling site.

Here, the structural analysis is desirably performed by a region division method. The region division method is an approach involving: dividing the entirety of a model to be subjected to the structural analysis into a plurality of regions; and producing a boundary integral equation for each of the regions, followed by the calculation of a strain energy release rate. Further, when a boundary portion between the regions does not peel, a constraint condition under which a displacement solution for the portion is always the same is set, and when the boundary portion between the regions peels, no constraint condition is set for the portion, and the calculation is performed while the portion is regarded as a free surface. At the time of the calculation of the strain energy release rate, as illustrated in FIG. 10, an adhesive member (1002) is divided into two or more regions (1004, 1005) so that the surface of a virtual peeling portion (1001) on the adhesive member side and the surface thereof on an adherend (1003) side become the surfaces of different regions. It is because the following situation needs to be prevented that the region division is performed as described above: when the boundary integral equations are produced, the combination of the equations in which an internodal distance between a nodal point on the adhesive surface of the adhesive member and a nodal point on the surface of the adherend becomes 0 occurs to preclude the calculation. A region can be set across the adhesive member and the adherend having different physical property values because the fundamental solution for the two-phase conjugate is used as a fundamental solution for a boundary integral equation.

<Calculation of Adhesion Profile Through Simulation>

A method of calculating an adhesion profile is illustrated in FIG. 11. First, as described above, the strain energy release rate G at a first peeling site (1103) when a force represented by the vector RF is applied to an adhesive member (1101) is determined. Further, the adhesive energy Δγ1 at the first peeling site is determined by, for example, an experimental approach or a molecular dynamics simulation. When G<Δγ1 is satisfied, no peeling from the first peeling site occurs, and hence conditions to be satisfied by a and b for maintaining an adhesion state are determined by solving the inequality.

The ranges of the magnitude and angle of the force vector in which no peeling occurs from the first peeling site can be determined by substituting the conditions into the equation RF=aRF_{L}+bRF_{N}. In addition, the ranges of the magnitude and angle of the force vector in which no peeling occurs from a second peeling site (1104) are similarly determined. Finally, the overlapping portion of the ranges of both the force vectors is plotted on two-dimensional coordinates using a horizontal direction component parallel to the adhesive surface of the adhesive member and a vertical direction component vertical thereto as axes. Thus, the adhesion profile is obtained.

### Example 2

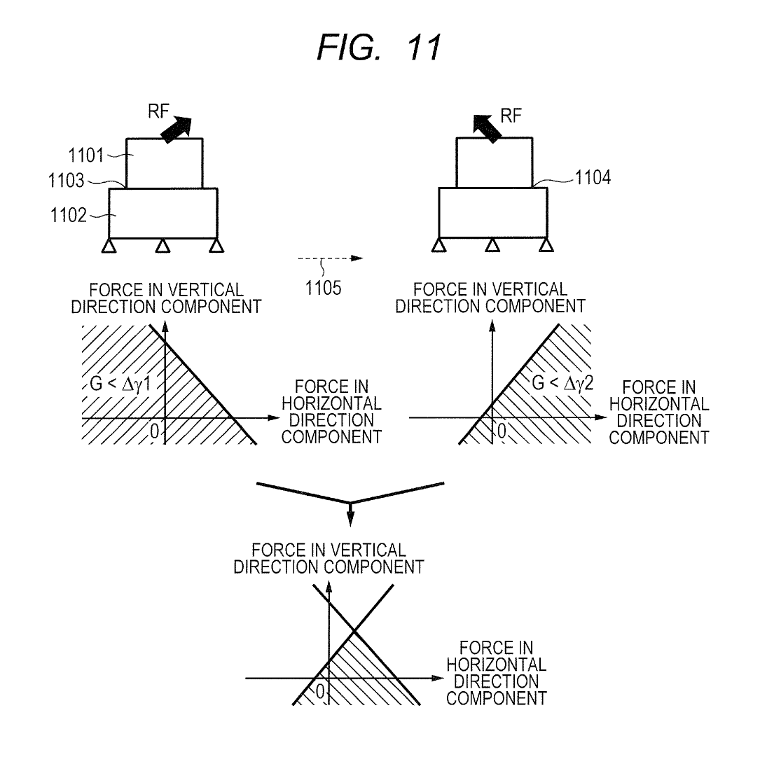

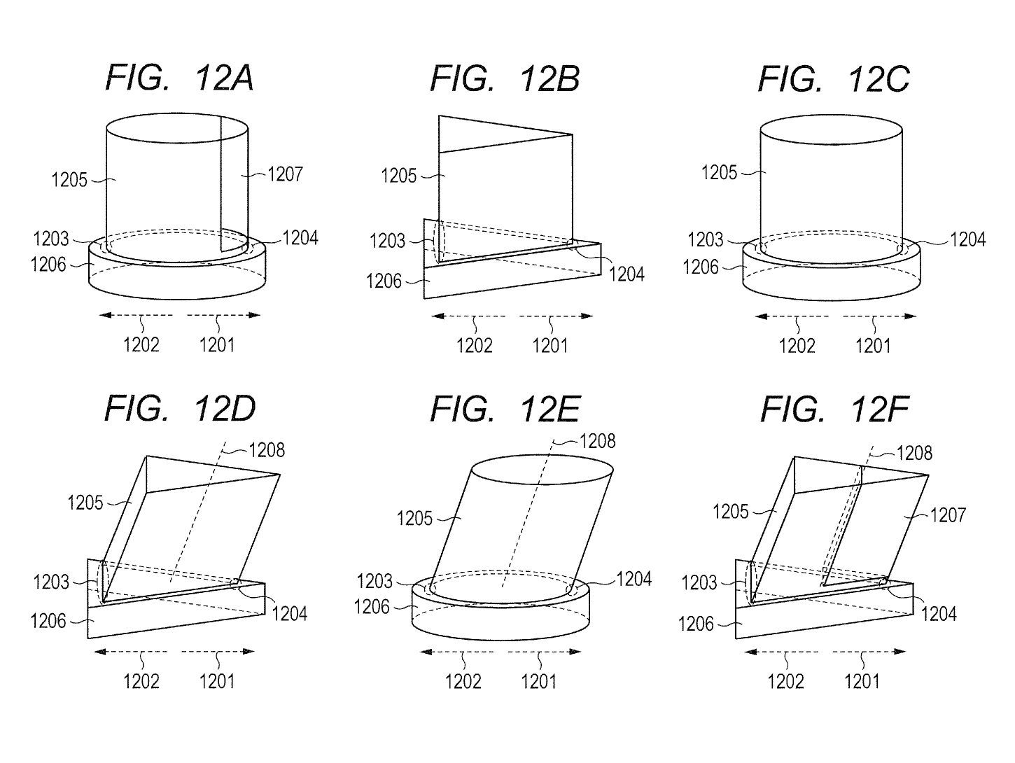

In Examples and Reference Examples below, the strength of the directional dependency of the adhesive force of an adhesive member and its adhesion profile are described. First, peeling sites were estimated by performing simple stress analysis before detailed analysis of the adhesive force. In each case, a first peeling site (1203) may be considered to be the end portion of the adhesive surface of an adhesive member (1205) in a second direction (1202), and a second peeling site (1204) may be considered to be the end portion of the adhesive surface in a first direction (1201) (FIG. 12A to FIG. 12F). A construction in which the adhesive member includes a plurality of protruding portions configured to adhere to an adherend and a substrate portion is, for example, a construction in which the adhesive member (1205) of each of FIG. 12A to FIG. 12F has the plurality of protruding portions in its lower portion. When the protruding portions are isotropic in a plane parallel to the adhesive surface, the directional dependency of the adhesive force of the adhesive member of the construction depends on a stress distribution in the substrate portion, indicated as 1205, and the adhesive energy distribution of the adhesive surface. Accordingly, the directional dependency of the adhesive force may be considered to appear in the adhesive member including the protruding portions as in Examples and Reference Examples below.

<Analysis of Adhesion Profile when Elastic Modulus is Nonuniformized>

An analysis model shape is illustrated in FIG. 12A. The shape of the adhesive member (1205) was a cylindrical shape having a diameter of 10 cm and a height of 10 cm. With regard to a portion having a height from the adhesive surface of 1 mm or more, the elastic modulus and Poisson's ratio of a region (1207) having a width of 2 cm on the first direction (1201) side were set to 29 MPa and 0.45, respectively. The elastic modulus and Poisson's ratio of the remaining region were set to 0.29 MPa and 0.45, respectively. In addition, the elastic modulus and Poisson's ratio of the adherend were set to 80 GPa and 0.21, respectively, and the shape of the adherend (1206) at the time of its structural analysis was a cylindrical shape having a diameter of 11 cm and a height of 1 cm. An adhesive energy between the adhesive member and the adherend was uniform over the entirety of the adhesive surface.

The strain energy release rate G1^{a} at the first peeling site (1203) in the case where a force of 1 N was applied in the first direction (1201) was 3.0 mJ/m². The strain energy release rate G2^{a} at the second peeling site (1204) in the case where a force of 1 N was applied in the second direction (1202) was 49 mJ/m². When both the adhesive energies Δγ1^{a} and Δγ2^{a} at the first peeling site and the second peeling site are 70 mJ/m², G1^{a}/Δγ1^{a}=0.042 and G2^{a}/Δγ2^{a}=0.69 are obtained. Accordingly, G1^{a}/Δγ1^{a}≠G2^{a}/Δγ2^{a} is satisfied. An adhesive force in the first direction was 1×(G1^{a}/Δγ1^{a})^{-1/2}=4.9 N and an adhesive force in the second direction was 1×(G2^{a}/Δγ2^{a})^{-1/2}=1.2 N, and hence directional dependency appeared in the adhesive force. In this case, the adhesive force in the first direction is stronger than the adhesive force in the second direction. The adhesion profile of the adhesive member is shown in FIG. 13. Accordingly, according to this example, the directional dependency appears in the adhesive force of the adhesive member by virtue of the effect of the nonuniformization of the elastic modulus of the adhesive member.

### Reference Example 1

### Analysis of Adhesion Profile when Horizontal Sectional Shape is Asymmetrized

An analysis model shape is illustrated in FIG. 12B. The shape of the adhesive member (1205) was a triangular prism shape whose horizontal section was an isosceles triangle having a base of 10 cm and a height of 10 cm, the shape having a height of 10 cm, and its elastic modulus and Poisson's ratio were set to 0.29 MPa and 0.45, respectively. In addition, the elastic modulus and Poisson's ratio of the adherend were set to 80 GPa and 0.21, respectively, and the shape of the adherend (1206) at the time of its structural analysis was a triangular prism shape whose section was an isosceles triangle having a base of 11 cm and a height of 11 cm, the shape having a height of 2 cm. The first direction (1201) is a direction vertical to the base of the horizontal section and directed toward the apex of the isosceles triangle. An adhesive energy between the adhesive member and the adherend was uniform over the entirety of the adhesive surface.

The strain energy release rate G1^{b} at the first peeling site (1203) in the case where a force of 1 N was applied in the first direction (1201) was 25 mJ/m². The strain energy release rate G2^{b} at the second peeling site (1204) in the case where a force of 1 N was applied in the second direction (1202) was 62 mJ/m². When both the adhesive energies Δγ1^{b} and Δγ2^{b} at the first peeling site and the second peeling site are 70 mJ/m², G1^{b}/Δγ1^{b}=0.036 and G2^{b}/Δγ2^{b}=0.89 are obtained. Accordingly, G1^{b}/Δγ1^{b}≠G2^{b}/Δγ2^{b} is satisfied.

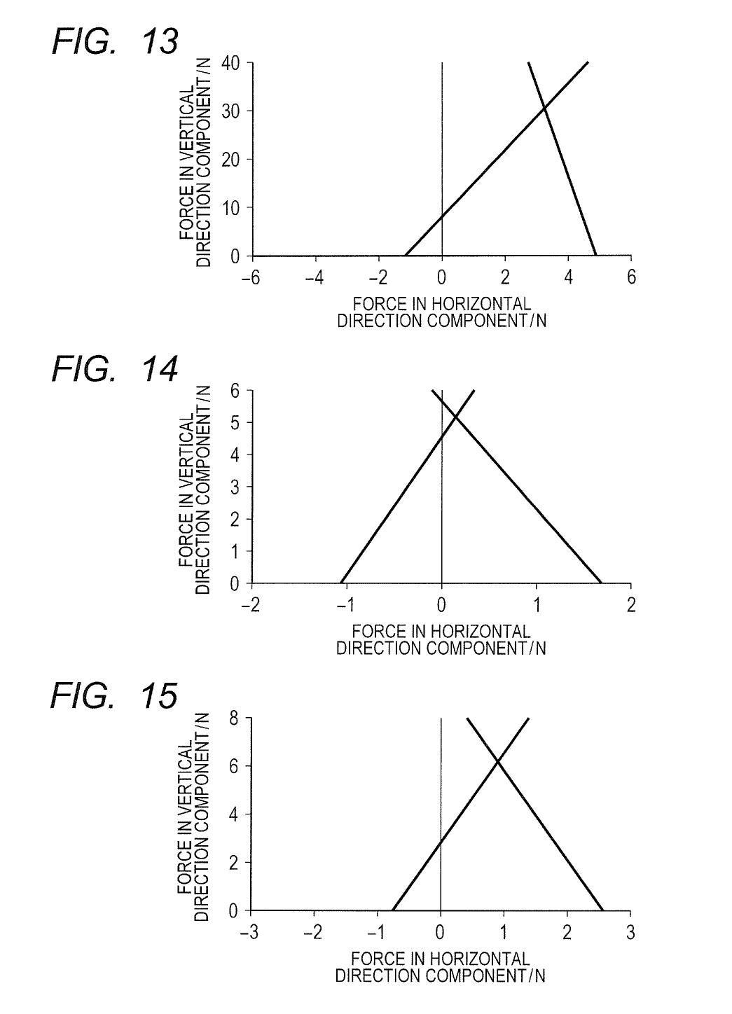

An adhesive force in the first direction was 1×(G1^{b}/Δγ1^{b})^{-1/2}=1.7 N and an adhesive force in the second direction was 1×(G2^{b}/Δγ2^{b})^{-1/2}=1.1 N, and hence directional dependency appeared in the adhesive force. In this case, the adhesive force in the first direction is stronger than the adhesive force in the second direction. The adhesion profile of the adhesive member is shown in FIG. 14. Accordingly, according to this example, the directional dependency appears in the adhesive force of the adhesive member by virtue of the effect of the asymmetrization of the horizontal sectional shape of the adhesive member.

### Reference Example 2

### Analysis of Adhesion Profile when Adhesive Energy is Nonuniformized

An analysis model shape is illustrated in FIG. 12C. The shape of the adhesive member (1205) was a cylindrical shape having a diameter of 10 cm and a height of 10 cm, and its elastic modulus and Poisson's ratio were set to 0.29 MPa and 0.45, respectively. In addition, the elastic modulus and Poisson's ratio of the adherend were set to 80 GPa and 0.21, respectively, and the shape of the adherend (1206) at the time of its structural analysis was a cylindrical shape having a diameter of 11 cm and a height of 2 cm. In addition, an adhesive energy between the adhesive member and the adherend was set to 7 mJ/m² in the half region of the adhesive surface on the first direction (1201) side, and was set to 70 mJ/m² in the half region thereof on the second direction (1202) side.

Accordingly, the adhesive energies Δγ1^{c} and Δγ2^{c} at the first peeling site (1203) and the second peeling site (1204) are 70 mJ/m² and 7 mJ/m², respectively, and hence the Δγ1^{c} and the Δγ2^{c} differ from each other. Strain energy release rates at the first peeling site and the second peeling site have the same value because both the shape and physical properties of the adhesive member are rotationally symmetric. In the case where a force of 1 N was applied in the first direction or the second direction, both the strain energy release rates G1^{c} and G2^{c} were 11 mJ/m². Accordingly, G1^{c}/Δγ1^{c}=0.16 and G2^{c}/Δγ2^{c}=1.6 are obtained. Thus, G1^{c}/Δγ1^{c}≠G2^{c}/Δγ2^{c} is satisfied.

An adhesive force in the first direction was 1×(G1^{c}/Δγ1^{c})^{-1/2}=2.5 N and an adhesive force in the second direction was 1×(G2^{c}/Δγ2^{c})^{-1/2}=0.80 N, and hence directional dependency appeared in the adhesive force. In this case, the adhesive force in the first direction is stronger than the adhesive force in the second direction. The adhesion profile of the adhesive member is shown in FIG. 15. Accordingly, according to this example, the directional dependency appears in the adhesive force of the adhesive member by virtue of the effect of causing the adhesive energies between the adhesive member and the adherend to differ from each other.

### Example 3

### Analysis of Adhesion Profile when Elastic Modulus is Nonuniformized and Adhesive Energy is Nonuniformized

The same analysis model shape as that of Example 2 was used (FIG. 12A). An adhesive energy between the adhesive member (1205) and the adherend (1206) was set to 7 mJ/m² in the half region of the adhesive surface on the first direction (1201) side, and was set to 70 mJ/m² in the half region thereof on the second direction (1202) side. Accordingly, the adhesive energies Δγ1^{a,c} and Δγ2^{a,c} at the first peeling site (1203) and the second peeling site (1204) are 70 mJ/m² and 7 mJ/m², respectively, and hence the Δγ1^{a,c} and the Δγ2^{a,c} differ from each other.

As in Example 2, the strain energy release rate G1^{a,c} at the first peeling site in the case where a force of 1 N is applied in the first direction is 3.0 mJ/m², and the strain energy release rate G2^{a,c} at the second peeling site in the case where a force of 1 N is applied in the second direction is 49 mJ/m². Accordingly, G1^{a,c}/Δγ1^{a,c}=0.042, G2^{a,c}/Δγ2^{a,c}=6.9 and hence G1^{a,c}/Δγ2^{a,c}/G2^{a,c}Δγ1^{a,c} 0.0061 are obtained. Thus, G1^{a,c}Δγ2^{a,c}/G2^{a,c}Δγ1^{a,c}≠1 is satisfied.

When the elastic modulus and Poisson's ratio of the adhesive member are assumed to have uniform values, both the shape and physical properties of the adhesive member are rotationally symmetric, and hence G1^{a-,c}=G2^{a-,c}. Accordingly, in the case of Δγ1^{a-,c}=Δγ1^{a,c}=70 mJ/m² and Δγ2^{a-,c}=Δγ2^{a,c}=7 mJ/m², G1^{a,c}Δγ2^{a-,c}/G2^{a-,c}Δγ1^{a-,c}=0.1 are obtained. Thus, G1^{a,c}Δγ2^{a,c}/G2^{a,c}Δγ1^{a,c}<G1^{a-,c}Δγ2^{a-,c}/G2^{a-,c}Δγ1^{a-,c}<1 is satisfied. An adhesive force in the first direction was 1×(G1^{a,c}/Δγ1^{a,c})^{-1/2}=4.9 N and an adhesive force in the second direction was 1×(G2^{a,c}/Δγ2^{a,c})^{-1/2}=0.38 N, and hence directional dependency appeared in the adhesive force. In this case, the adhesive force in the first direction is stronger than the adhesive force in the second direction.

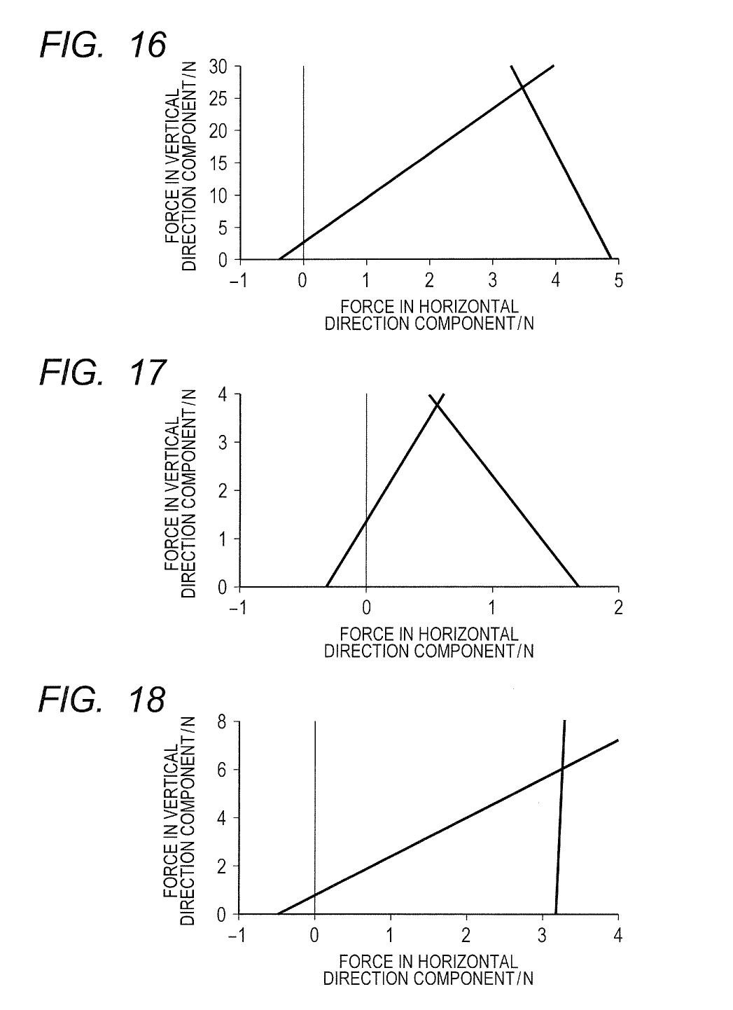

The adhesion profile of the adhesive member is shown in FIG. 16. Here, the strength of the directional dependency of the adhesive force is represented by R=(adhesive force in the second direction)/(adhesive force in the first direction). When the adhesive force in the first direction is stronger than the other, the directional dependency of the adhesive force strengthens as the value reduces, and when the adhesive force in the second direction is stronger than the other, the directional dependency strengthens as the value increases. The adhesive member of this example had an R of 0.078 and hence showed high directional dependency. On the other hand, when the elastic modulus and Poisson's ratio of the adhesive member are assumed to have uniform values, R={1×(G2^{a-,c}/Δγ2^{a-,c})^{-1/2}}/{1×(G1^{a-,c}/Δγ1^{a-,c})^{-1/2}}=0.32 is obtained. In other words, the nonuniformization of the elastic modulus and the nonuniformization of the adhesive energy effectively improve the directional dependency of the adhesive force. Accordingly, according to this example, the effect of the nonuniformization of the elastic modulus of the adhesive member, and the effect of causing the adhesive energies of the adhesive member to differ from each other strengthen each other, and hence additionally high directional dependency appears in the adhesive force of the adhesive member.

### Reference Example 3

### Analysis of Adhesion Profile when Horizontal Sectional Shape is Asymmetrized and Adhesive Energy is Nonuniformized

The same analysis model shape as that of Reference Example 1 was used (FIG. 12B). An adhesive energy between the adhesive member (1205) and the adherend (1206) was set to 7 mJ/m² in the half region of the adhesive surface on the first direction (1201) side, and was set to 70 mJ/m² in the half region thereof on the second direction (1202) side.

Accordingly, the adhesive energies Δγ1^{b,c} and Δγ2^{b,c} at the first peeling site (1203) and the second peeling site (1204) are 70 mJ/m² and 7 mJ/m², respectively, and hence the Δγ1^{b,c} and the Δγ2^{b,c} differ from each other. As in Reference Example 1, the strain energy release rate G1^{b,c} at the first peeling site in the case where a force of 1 N is applied in the first direction is 25 mJ/m², and the strain energy release rate G2^{b,c} at the second peeling site in the case where a force of 1 N is applied in the second direction is 62 mJ/m². Accordingly, G1^{b,c}/Δγ1^{b,c}=0.36 and G2^{b,c}/Δγ2^{b,c}=8.9 and hence G1^{b,c}Δγ2^{b,c}/G2^{b,c}Δγ1^{b,c}=0.040 are obtained. Thus G1^{b,c}Δγ2^{b,c}/G2^{b,c}Δγ1^{b,c}≠1 is satisfied.

When the adhesive energy at the first peeling site and the adhesive energy at the second peeling site are assumed to be equal to each other, Δγ1^{b,c}=Δγ2^{b,c-}. accordingly, G1^{a,b-}=G1^{b,c}=25 mJ/m² and G2^{b,c-}=G2^{b,c}=62 mJ/m², and hence G1^{b,c-}Δγ2^{b,c-}/G2^{b,c-}Δγ1^{b,c-}=0.40 are obtained. Thus, G1^{b,c}Δγ2^{b,c}/G2^{b,c}Δγ1^{b,c}<G1^{b,c-}Δγ2^{b,c-}/G2^{b,c-}Δγ1^{b,c-}<1 is satisfied. An adhesive force in the first direction was 1×(G1^{b,c}/Δγ1^{b,c})^{-1/2}=1.7 N and an adhesive force in the second direction was 1×(G2^{b,c}/Δγ2^{b,c})^{-1/2}=0.34 N, and hence directional dependency appeared in the adhesive force. In this case, the adhesive force in the first direction is stronger than the adhesive force in the second direction.

The adhesion profile of the adhesive member is shown in FIG. 17. The strength R of the directional dependency of the adhesive force in this example was 0.20, i.e., high directional dependency was shown. When the adhesive energy at the first peeling site and the adhesive energy at the second peeling site are assumed to be equal to each other, R={1×(G2^{b,c-}/Δγ2^{b,c-})^{-1/2}}/{1×(G1^{b,c-}/Δγ1^{b,c-})^{-1/2}}=0.63 is obtained. In other words, the asymmetrization of the horizontal sectional shape and the nonuniformization of the adhesive energy effectively improve the directional dependency of the adhesive force. Accordingly, according to this example, the effect of the asymmetrization of the horizontal sectional shape of the adhesive member, and the effect of causing the adhesive energies between the adhesive member and the adherend to differ from each other strengthen each other, and hence additionally high directional dependency appears in the adhesive force of the adhesive member.

### Reference Example 4

### Analysis of Adhesion Profile when Horizontal Sectional Shape is Asymmetrized and Vertical Sectional Shape is Asymmetrized

An analysis model shape is illustrated in FIG. 12D. The shape of the adhesive member (1205) was an inclined triangular prism shape having a height of 10 cm, and an angle formed between an axis (1208) and the first direction (1201) was set to 60°. The shape of a horizontal section of the adhesive member was an isosceles triangle having a base of 10 cm and a height of 10 cm, and the direction of the section was as follows: the base of the isosceles triangle was vertical to the first direction, and its apex was directed toward the first direction. A vertical section of the adhesive member is of a parallelogram shape and is bilaterally asymmetrized. The elastic modulus and Poisson's ratio of the adhesive member were set to 0.29 MPa and 0.45, respectively. In addition, the elastic modulus and Poisson's ratio of the adherend were set to 80 GPa and 0.21, respectively, and the shape of the adherend (1206) at the time of its structural analysis was a triangular prism shape whose section was an isosceles triangle having a base of 11 cm and a height of 11 cm, the shape having a height of 2 cm. An adhesive energy between the adhesive member and the adherend was uniform over the entirety of the adhesive surface.

The strain energy release rate G1^{b,d} at the first peeling site (1203) in the case where a force of 1 N was applied in the first direction (1201) was 7.0 mJ/m². The strain energy release rate G2^{b,d} at the second peeling site (1204) in the case where a force of 1 N was applied in the second direction (1202) was 290 mJ/m². When both the adhesive energies Δγ1^{b,d} and Δγ2^{b,d} at the first peeling site and the second peeling site are 70 mJ/m², G1^{b,d}/Δγ1^{b,d}=0.10 and G2^{b,d}/Δγ2^{b,d}=4.1 and hence G1^{b,d}Δγ2^{b,d}/G2^{b,d}Δγ1^{b,d}=0.024 are obtained. Thus, G1^{b,d}Δγ2^{b,d}/G2^{b,d}Δγ1^{b,d}≠1 is satisfied.

When the vertical sectional shape of the adhesive member parallel to the first direction is assumed to be bilaterally symmetric, G1^{b,d}=25 mJ/m² and G2^{b,d-}=62 mJ/m² based on Reference Example 1. Δγ1^{b,d-}=Δγ1^{b,d}=Δγ2^{b,d-}×Δγ2^{b,d}×70 mJ/m², and hence G1^{b,d-}Δγ2^{b,d-}/G2^{b,d-}Δγ1^{b,d-}=0.40. Thus, G1^{b,d}Δγ2^{b,c}/G2^{b,d}Δγ1^{b,d}<G1^{b,d-}Δγ2^{b,d-}/G2^{b,d-}Δγ1^{b,d-}<1 is satisfied.

An adhesive force in the first direction was 1×(G1^{b,d}/Δγ1^{b,d})^{-1/2}=3.2 N and an adhesive force in the second direction was 1×(G2^{b,d}/Δγ2^{b,d})^{-1/2}=0.49 N, and hence directional dependency appeared in the adhesive force. In this case, the adhesive force in the first direction is stronger than the adhesive force in the second direction.

The adhesion profile of the adhesive member is shown in FIG. 18. The strength R of the directional dependency of the adhesive force in this example was 0.15, i.e., high directional dependency was shown. When the vertical sectional shape of the adhesive member parallel to the first direction is assumed to be bilaterally symmetric, R={1×(G2^{b,d-}/Δγ2^{b,d-})^{-1/2}}/{1×(G1^{b,d-}/Δγ1^{b,d-})^{-1/2}}×0.63. In other words, the asymmetrization of the horizontal sectional shape and the asymmetrization of the vertical sectional shape effectively improve the directional dependency of the adhesive force. Accordingly, according to this example, the effect of the asymmetrization of the horizontal sectional shape of the adhesive member, and the effect of the asymmetrization of the vertical sectional shape of the adhesive member strengthen each other, and hence additionally high directional dependency appears in the adhesive force of the adhesive member.

### Reference Example 5

### Analysis of Adhesion Profile when Adhesive Energy is Nonuniformized and Vertical Sectional Shape is Asymmetrized

An analysis model shape is illustrated in FIG. 12E. The shape of the adhesive member (1205) was an inclined cylindrical shape having a diameter of 10 cm and a height of 10 cm, and an angle formed between the axis (1208) and the first direction (1201) was set to 60°. A vertical section of the adhesive member is of a parallelogram shape and is bilaterally asymmetrized. The elastic modulus and Poisson's ratio of the adhesive member were set to 0.29 MPa and 0.45, respectively. In addition, the elastic modulus and Poisson's ratio of the adherend were set to 80 GPa and 0.21, respectively, and the shape of the adherend (1206) at the time of its structural analysis was a cylindrical shape having a diameter of 11 cm and a height of 1 cm.

Further, an adhesive energy between the adhesive member and the adherend was set to 7 mJ/m² in the half region of the adhesive surface on the first direction side, and was set to 70 mJ/m² in the half region thereof on the second direction (1202) side. Accordingly, the adhesive energies Δγ1^{c,d} and Δγ2^{c,d} at the first peeling site (1203) and the second peeling site (1204) are 70 mJ/m² and 7 mJ/m², respectively, and hence the Δγ1^{c,d} and the Δγ2^{c,d} differ from each other. The strain energy release rate G1^{c,d} at the first peeling site in the case where a force of 1 N was applied in the first direction was 1.7 mJ/m², and the strain energy release rate G2^{c,d} at the second peeling site in the case where a force of 1 N was applied in the second direction was 30 mJ/m². Accordingly, G1^{c,d}/Δγ1^{c,d}=0.024, G2^{c,d}/Δγ2^{c,d}=4.3 and hence G1^{c,d}Δγ2^{c,d}/G2^{c,d}Δγ1^{c,d}=0.0055 are obtained. Thus, G1^{c,d}Δγ2^{c,d}/G2^{c,d}Δγ1^{c,d}≠1 is satisfied.

When the adhesive energy at the first peeling site and the adhesive energy at the second peeling site are assumed to be equal to each other, Δγ1^{c-,d}=Δγ2^{c-,d}. In the case of G1^{c-,d}=G1^{c,d}=1.7 mJ/m² and G2^{c-,d}=G2^{c,d} 30 mJ/m², G1^{c-,d}Δγ2^{c-,d}/G2^{c-,d}Δγ1^{c-,d}=0.055 is obtained. Thus, G1^{c,d}Δγ2^{c,d}/G2^{c,d}Δγ1^{c,d}<G1^{c-,d}Δγ^{2c-,d}/G2^{c-,d}Δγ1^{c-,d}<1 is satisfied. An adhesive force in the first direction was 1×(G1^{c,d}/Δγ1^{c,d})^{-1/2}=6.5 N and an adhesive force in the second direction was 1×(G2^{c,d}/Δγ2^{c,d})^{-1/2}×0.48 N, and hence directional dependency appeared in the adhesive force. In this case, the adhesive force in the first direction is stronger than the adhesive force in the second direction.

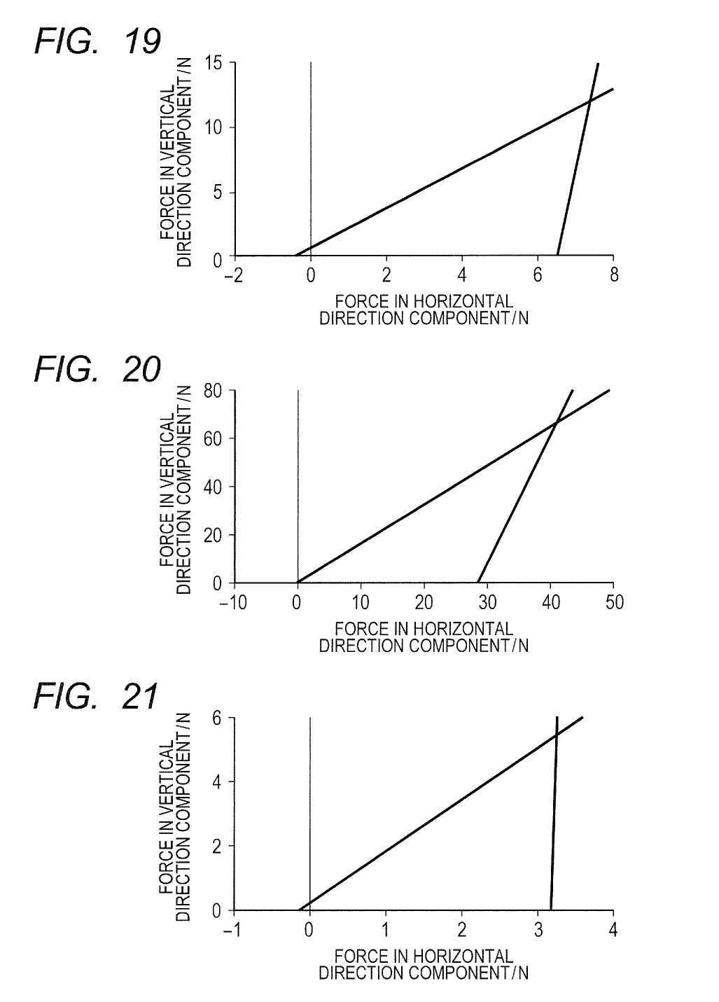

The adhesion profile of the adhesive member is shown in FIG. 19. The strength R of the directional dependency of the adhesive force in this example was 0.074, i.e., high directional dependency was shown. When the adhesive energy at the first peeling site and the adhesive energy at the second peeling site are assumed to be equal to each other, R={1×(G2^{c-,d}/Δγ2^{c-,d})^{-1/2}}/{1×(G1^{c-,d}/Δγ1^{c-,d})^{-1/2}}=0.23 is obtained. In other words, the nonuniformization of the adhesive energy and the asymmetrization of the vertical sectional shape effectively improve the directional dependency of the adhesive force. Accordingly, according to this example, the effect of causing the adhesive energies between the adhesive member and the adherend to differ from each other, and the effect of the asymmetrization of the vertical sectional shape of the adhesive member strengthen each other, and hence additionally high directional dependency appears in the adhesive force of the adhesive member.

### Example 4

### Analysis of Adhesion Profile when Elastic Modulus is Nonuniformized, Horizontal Sectional Shape is Asymmetrized, and Vertical Sectional Shape is Asymmetrized

An analysis model shape is illustrated in FIG. 12F. The shape of the adhesive member (1205) was an inclined triangular prism shape having a height of 10 cm, and an angle formed between the axis (1208) and the first direction (1201) was set to 60°. The shape of a horizontal section of the adhesive member was an isosceles triangle having a base of 10 cm and a height of 10 cm, and the direction of the section was as follows: the base of the isosceles triangle was vertical to the first direction, and its apex was directed toward the first direction. A vertical section of the adhesive member is of a parallelogram shape and is bilaterally asymmetrized. The elastic modulus and Poisson's ratio of the region (1207) of the adhesive member having a height from the adhesive surface of 1 mm or more and having a width of 5 cm on the first direction side of the horizontal section were set to 29 MPa and 0.45, respectively. The elastic modulus and Poisson's ratio of the remaining region were set to 0.29 MPa and 0.45, respectively.

In addition, the elastic modulus and Poisson's ratio of the adherend were set to 80 GPa and 0.21, respectively, and the shape of the adherend (1206) at the time of its structural analysis was a triangular prism shape whose section was an isosceles triangle having a base of 11 cm and a height of 11 cm, the shape having a height of 2 cm. An adhesive energy between the adhesive member and the adherend was uniform over the entirety of the adhesive surface. The strain energy release rate G1 at the first peeling site (1203) in the case where a force of 1 N was applied in the first direction (1201) was 0.090 mJ/m². The strain energy release rate G2 at the second peeling site (1204) in the case where a force of 1 N was applied in the second direction (1202) was 97 mJ/m².

When both the adhesive energies Δγ1 and Δγ2 at the first peeling site and the second peeling site are 70 mJ/m², G1/Δγ1=0.0013 and G2/Δγ2=1.4 and hence G1Δγ2/G2Δγ1=9.3×10⁻⁴ are obtained. Thus, G1Δγ2/G2Δγ1≠1 is satisfied.

In this example, the three characteristics, i.e., the nonuniformization of the elastic modulus, the asymmetrization of the horizontal sectional shape, and the asymmetrization of the vertical sectional shape are properly combined with one another so that the value for the G1Δγ2/G2Δγ1 becomes additionally small under the condition of G1Δγ2/G2Δγ1<1, though details about the foregoing are omitted. An adhesive force in the first direction was 1×(G1/Δγ1)^{-1/2}=28 N and an adhesive force in the second direction was 1×(G2/Δγ2)^{-1/2}=0.85 N, and hence directional dependency appeared in the adhesive force. In this case, the adhesive force in the first direction is stronger than the adhesive force in the second direction.

The adhesion profile of the adhesive member is shown in FIG. 20. The strength R of the directional dependency of the adhesive force in this example was 0.030, i.e., extremely high directional dependency was shown. This is because in this example, the three characteristics, i.e., the nonuniformization of the elastic modulus, the asymmetrization of the horizontal sectional shape, and the asymmetrization of the vertical sectional shape are properly combined with one another so that the value for the G1Δγ2/G2Δγ1 becomes additionally small under the condition of G1Δγ2/G2Δγ1<1. In other words, the respective characteristics effectively improve the directional dependency of the adhesive force. Accordingly, according to this example, the effect of the nonuniformization of the elastic modulus of the adhesive member, the effect of the asymmetrization of the horizontal sectional shape of the adhesive member, and the effect of the asymmetrization of the vertical sectional shape of the adhesive member strengthen one another, and hence extremely high directional dependency appears in the adhesive force of the adhesive member.

### Reference Example 6

### Analysis of Adhesion Profile when Horizontal Sectional Shape is Asymmetrized, Adhesive Energy is Nonuniformized, and Vertical Sectional Shape is Asymmetrized

The same analysis model shape as that of Reference Example 4 was used (FIG. 12D). An adhesive energy between the adhesive member (1205) and the adherend (1206) was set to 7 mJ/m² in the half region of the adhesive surface on the first direction (1201) side, and was set to 70 mJ/m² in the half region thereof on the second direction (1202) side. Accordingly, the adhesive energies Δγ1 and Δγ2 at the first peeling site (1203) and the second peeling site (1204) are 70 mJ/m² and 7 mJ/m², respectively, and hence the Δγ1 and the Δγ2 differ from each other. As in Reference Example 4, the strain energy release rate G1 at the first peeling site in the case where a force of 1 N is applied in the first direction is 7.0 mJ/m², and the strain energy release rate G2 at the second peeling site in the case where a force of 1 N is applied in the second direction is 290 mJ/m². Accordingly, G1/Δγ1=0.10 and G2/Δγ2=41. Thus, G1Δγ2/G2Δγ1=0.0024 and hence G1Δγ2/G2Δγ1≠1 is satisfied.

In this example, the three characteristics, i.e., the asymmetrization of the horizontal sectional shape, the nonuniformization of the adhesive energy, and the asymmetrization of the vertical sectional shape are properly combined with one another so that the value for the G1Δγ2/G2Δγ1 becomes additionally small under the condition of G1Δγ2/G2Δγ1<1, though details about the foregoing are omitted. An adhesive force in the first direction was 1×(G1/Δγ1)^{-1/2}=3.2 N and an adhesive force in the second direction was 1×(G2/Δγ2)^{-1/2}=0.16 N, and hence directional dependency appeared in the adhesive force. In this case, the adhesive force in the first direction is stronger than the adhesive force in the second direction.

The adhesion profile of the adhesive member is shown in FIG. 21. The strength R of the directional dependency of the adhesive force in this example was 0.049, i.e., extremely high directional dependency was shown. This is because in this example, the three characteristics, i.e., the asymmetrization of the horizontal sectional shape, the nonuniformization of the adhesive energy, and the asymmetrization of the vertical sectional shape are properly combined with one another so that the value for the G1Δγ2/G2Δγ1 becomes additionally small under the condition of G1Δγ2/G2Δγ1<1. In other words, the respective characteristics effectively improve the directional dependency of the adhesive force. Accordingly, according to this example, the following effects strengthen one another, and hence extremely high directional dependency appears in the adhesive force of the adhesive member: the effect of the asymmetrization of the horizontal sectional shape of the adhesive member; the effect of causing the adhesive energies between the adhesive member and the adherend to differ from each other; and the effect of the asymmetrization of the vertical sectional shape of the adhesive member.

### Example 5

### Analysis of Adhesion Profile when Elastic Modulus is Nonuniformized, Horizontal Sectional Shape is Asymmetrized, Adhesive Energy is Nonuniformized, and Vertical Sectional Shape is Asymmetrized

The same analysis model shape as that of Example 4 was used (FIG. 12F). An adhesive energy between the adhesive member (1205) and the adherend (1206) was set to 7 mJ/m² in the half region of the adhesive surface on the first direction (1201) side, and was set to 70 mJ/m² in the half region thereof on the second direction (1202) side. Accordingly, the adhesive energies Δγ1 and Δγ2 at the first peeling site (1203) and the second peeling site (1204) are 70 mJ/m² and 7 mJ/m², respectively, and hence the Δγ1 and the Δγ2 differ from each other. As in Example 4, the strain energy release rate G1 at the first peeling site in the case where a force of 1 N is applied in the first direction is 0.090 mJ/m², and the strain energy release rate G2 at the second peeling site in the case where a force of 1 N is applied in the second direction is 97 mJ/m². Accordingly, G1/Δγ1=0.0013, G2/Δγ2=14 and hence G1Δγ2/G2Δγ1=9.3×10⁻⁵ are obtained, Thus G1Δγ2/G2Δγ1≠1 is satisfied.

In this example, the four characteristics, i.e., the nonuniformization of the elastic modulus, the asymmetrization of the horizontal sectional shape, the nonuniformization of the adhesive energy, and the asymmetrization of the vertical sectional shape are properly combined with one another so that the value for the G1Δγ2/G2Δγ1 becomes additionally small under the condition of G1Δγ2/G2Δγ1<1, though details about the foregoing are omitted. An adhesive force in the first direction was 1×(G1/Δγ1)^{-1/2}=28 N and an adhesive force in the second direction was 1×(G2/Δγ2)^{-1/2}=0.27 N, and hence directional dependency appeared in the adhesive force. In this case, the adhesive force in the first direction is stronger than the adhesive force in the second direction.

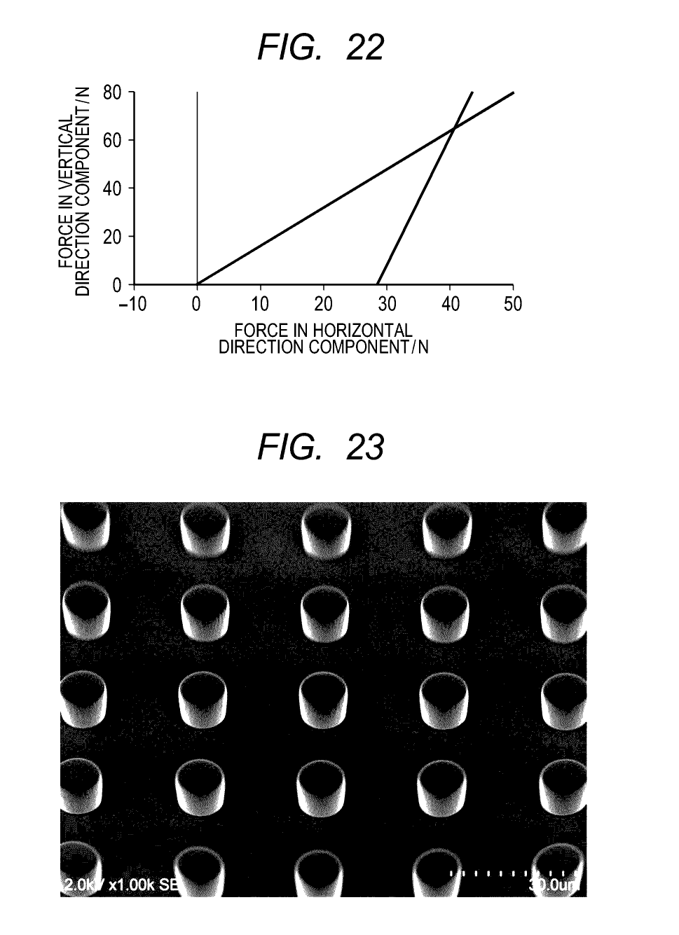

The adhesion profile of the adhesive member is shown in FIG. 22. The strength R of the directional dependency of the adhesive force in this example was 0.0096, i.e., particularly high directional dependency was shown. This is because in this example, the four characteristics, i.e., the nonuniformization of the elastic modulus, the asymmetrization of the horizontal sectional shape, the nonuniformization of the adhesive energy, and the asymmetrization of the vertical sectional shape are properly combined with one another so that the value for the G1Δγ2/G2Δγ1 becomes additionally small under the condition of G1Δγ2/G2Δγ1<1. In other words, the respective characteristics effectively improve the directional dependency of the adhesive force. Accordingly, according to this example, the following effects strengthen one another, and hence particularly high directional dependency appears in the adhesive force of the adhesive member: the effect of the nonuniformization of the elastic modulus of the adhesive member; the effect of the asymmetrization of the horizontal sectional shape of the adhesive member; the effect of causing the adhesive energies between the adhesive member and the adherend to differ from each other; and the effect of the asymmetrization of the vertical sectional shape of the adhesive member.

### Reference Example 7

Subsequently, an example of a method of producing an adhesive member including a plurality of protruding portions configured to adhere to an adherend, and an example of the result of the actual evaluation of an adhesion profile are described.

<Method of Producing Adhesive Member Having Protruding Portions>

The adhesive member having the plurality of protruding portions is produced by molding a polymer resin with a mold imitating the shapes of the protruding portions. A method of producing the mold is as described below.

First, a chromium mask in accordance with the shapes and pattern of the protruding portions is produced on a glass wafer by an ordinary method. Next, the top of the chromium surface is spin-coated with a photoresist (trade name: AZP4903, AZ Electronic Materials). Further, the photoresist is exposed to light from the glass wafer side and developed by an ordinary method. Thus, a resist pattern serving as the mold is obtained. A method of molding the polymer resin is as described below.

The top of the resist pattern is spin-coated with a mixed liquid containing a base polymer for polydimethylsiloxane (trade name: Sylgard 184, Dow Corning Toray Co., Ltd., hereinafter referred to as “PDMS”) and a catalyst at a ratio of 10:1, and then the liquid is thermally cured at 100° C. over 1 hour. A sheet of the PDMS is isolated by dissolving the resist with acetone, and is washed with acetone several times and dried in a vacuum.

Thus, the adhesive member including the plurality of protruding portions and a substrate portion was produced as an integrated product. The shapes of the protruding portions present in the adhesive member were each a cylindrical shape having a diameter of 10 μm and a height of 10 μm, and a distance between the centers of the cylindrical bottom surfaces of the protruding portions adjacent to each other was set to 30 μm. In addition, the substrate portion was of a 1-centimeter square size and had a thickness of 100 μm. An image obtained by observing the adhesive member with a scanning electron microscope (hereinafter referred to as “SEM”) is shown in FIG. 23.

<Method of Producing Adhesive Member Whose Adhesive Energy is Nonuniformized>

A method of nonuniformizing the adhesive energy of an adhesive member is as described below. Described here is a method involving: dividing the adhesive surface of an adhesive member having a plurality of protruding portions into two regions including a first peeling site and a second peeling site, respectively; and causing the adhesive energies of the two regions to differ from each other. The direction in which the adhesive force of the adhesive member was stronger than that in the other direction was defined as a first direction.

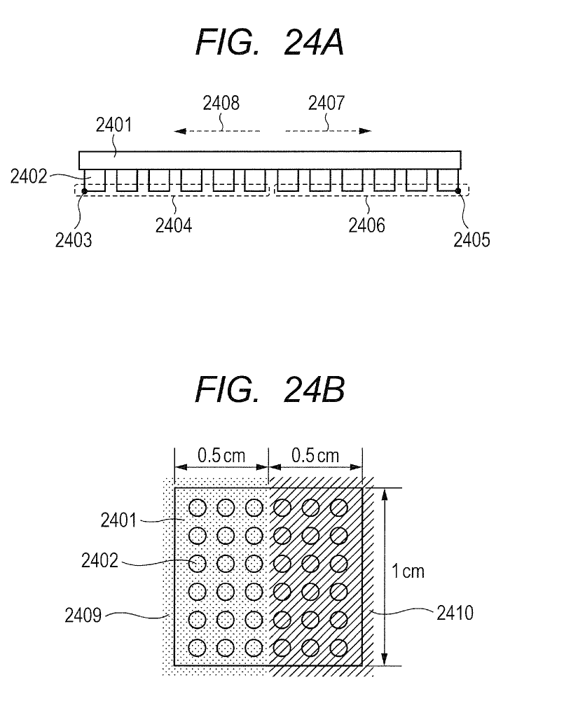

In this reference example, as illustrated in FIG. 24A, the adhesive member includes a plurality of protruding portions (2402) and a substrate portion (2401). Further, the adhesive surface is divided into two regions, i.e., a region (2404) including a first peeling site (2403) and a region (2406) including a second peeling site (2405), and the respective regions have a substantially uniform adhesive energy.

When an adhesive member showing such directional dependency that its adhesive force in a first direction (2407) becomes stronger than that in the other direction is produced, the adhesive energy of the region including the first peeling site (2403) needs to be made larger than the adhesive energy of the region including the second peeling site (2405). In view of the foregoing, the adhesive energy of the region including the first peeling site was increased by partially irradiating the adhesive member with vacuum ultraviolet (hereinafter referred to as “VUV”).

Specifically, as illustrated in FIG. 24B, only a half area (2409) of a 1-centimeter square adhesive member was irradiated with VUV, and a remaining half area (2410) thereof was shielded from VUV with a photomask. The VUV irradiation was performed with an excimer lamp (product name: EX-Mini, Hamamatsu Photonics K.K., wavelength: 172 nm) for 60 seconds under the conditions of an irradiation intensity of 50 mW/cm² and a distance from the lamp to the adhesive member of about 10 mm. To confirm a change in adhesive energy by the VUV irradiation, a water contact angle after the VUV irradiation was measured by using a polydimethylsiloxane (PDMS) plane separately produced on a glass wafer.

While the PDMS plane not irradiated with VUV showed a water contact angle of 108°, the PDMS plane irradiated with VUV showed a water contact angle of 10° or less. A reduction in water contact angle means that the surface of the PDMS is hydrophilically modified to have a higher surface free energy, i.e., a higher adhesive energy.

Thus, the adhesive member in which the adhesive energy of the region including the first peeling site was made higher than the adhesive energy of the region including the second peeling site was obtained.

<Actual Evaluation of Adhesion Profile>

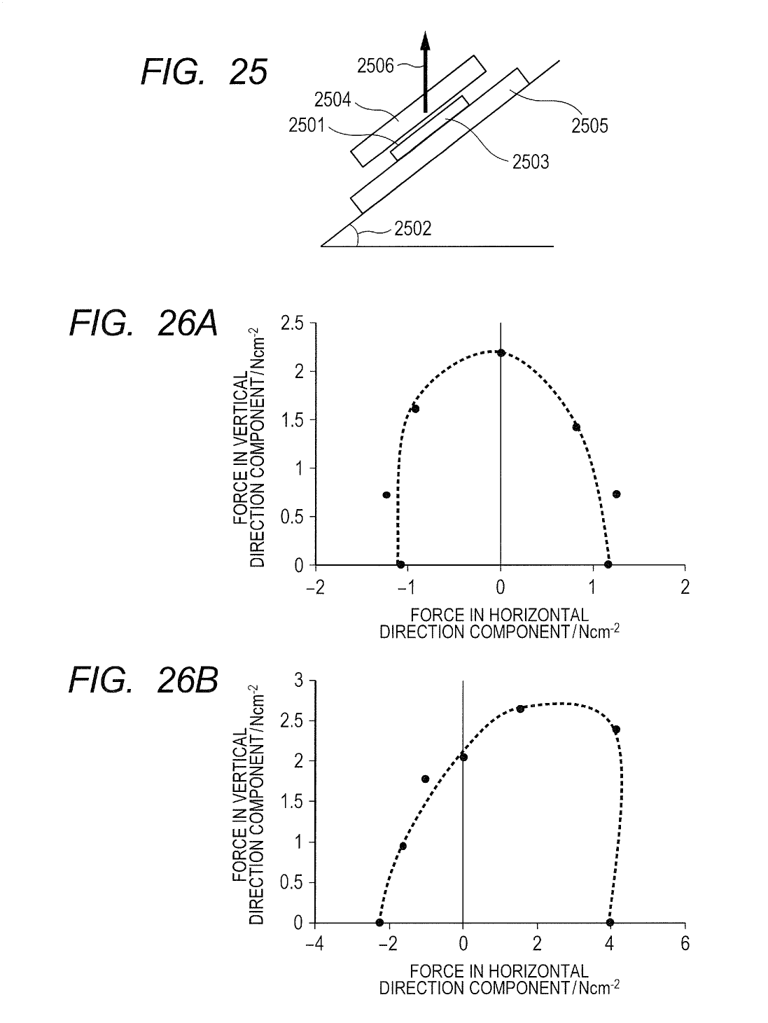

The adhesive force of an adhesive member was measured with a texture analyzer (TA. XT Plus, Stable Micro Systems Ltd.). The apparatus has a uniaxial force sensor and a uniaxially driven linear actuator. An adhesive member of a 1-centimeter square size was used and a flat glass plate was used as an adherend. As illustrated in FIG. 25, an angle between a force (2506) for pulling up the adherend and an adhesive surface (2501) was changed by changing an angle (2502) at which a sample stage (2505) having fixed thereto an adhesive member (2503) was placed, and a force when the adhesive member peeled from the adherend (2504) was measured. An adhesion profile was obtained by: dividing the resultant adhesive force by the area of the adhesive member to normalize the force; decomposing the force into a force in a vertical direction component and a force in a horizontal direction component; and plotting the forces. The adhesion profiles of the adhesive member of this example in which the adhesive energies of the adhesive surface at the first peeling site and the second peeling site were caused to differ from each other by the VUV irradiation, and an adhesive member having a uniform adhesive energy before the VUV irradiation serving as a comparative example were measured.

First, the adhesion profile of the adhesive member whose adhesive surface has a uniform adhesive energy is shown in FIG. 26A. The adhesion profile is bilaterally symmetric, and hence the member shows a strong adhesive force when pulled in the height direction of each of its protruding portions. Next, the adhesion profile of the adhesive member in which the adhesive energies of the adhesive surface at the first peeling site and the second peeling site are caused to differ from each other by the VUV irradiation is shown in FIG. 26B. It was found that the adhesion profile was bilaterally asymmetric, and hence the adhesive member showed the directional dependency of the adhesive force. The absolute values of positive and negative adhesive forces in a horizontal direction per unit area were 4.0 N/cm² and 2.3 N/cm², respectively, and the strength R of the directional dependency of the adhesive force was 0.57.

It was confirmed from the foregoing that according to this reference example, the adhesive force of the adhesive member showed high directional dependency by virtue of the effect of causing the adhesive energies at the first peeling site and the second peeling site to differ from each other.

### Example 6

### Method of Producing Adhesive Member Whose Elastic Modulus is Nonuniformized

A method of nonuniformizing the elastic modulus of an adhesive member is as described below. Described here is a method involving causing the elastic moduli of two portions of an adhesive member having a plurality of protruding portions including a first peeling site and a second peeling site, respectively to differ from each other. The direction in which the adhesive force of the adhesive member was stronger than that in the other direction was defined as a first direction.

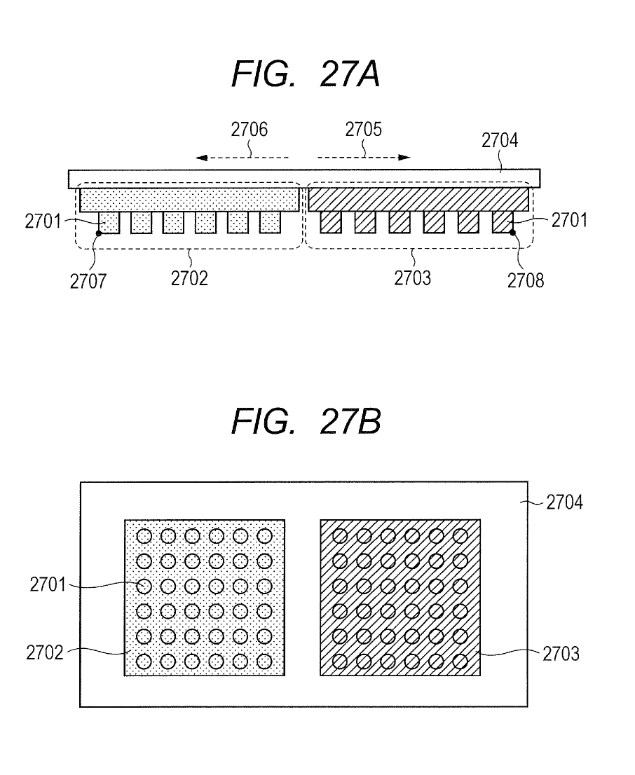

For reasons in terms of production, a rough construction of the adhesive member in this example was as illustrated in FIG. 27A and FIG. 27B. That is, the adhesive member includes an A portion (2702) and a B portion (2703) each having a plurality of protruding portions (2701), and further includes a substrate portion (2704) for fixing the A portion and the B portion.

When the A portion is placed on a second direction (2706) side, and the B portion is placed on a first direction (2705) side, a first peeling site (2707) is present in a protruding portion of the A portion, and a second peeling site (2708) is present in a protruding portion of the B portion. In addition, when the elastic modulus of the A portion is made lower than the elastic modulus of the B portion, such directional dependency that the adhesive force in the first direction (2705) becomes stronger than that in the second direction appears. In view of the foregoing, a material having a low elastic modulus was used at the time of the production of the A portion, and a material having a high elastic modulus was used at the time of the production of the B portion. Thus, the adhesive member whose elastic modulus is nonuniformized can be obtained.

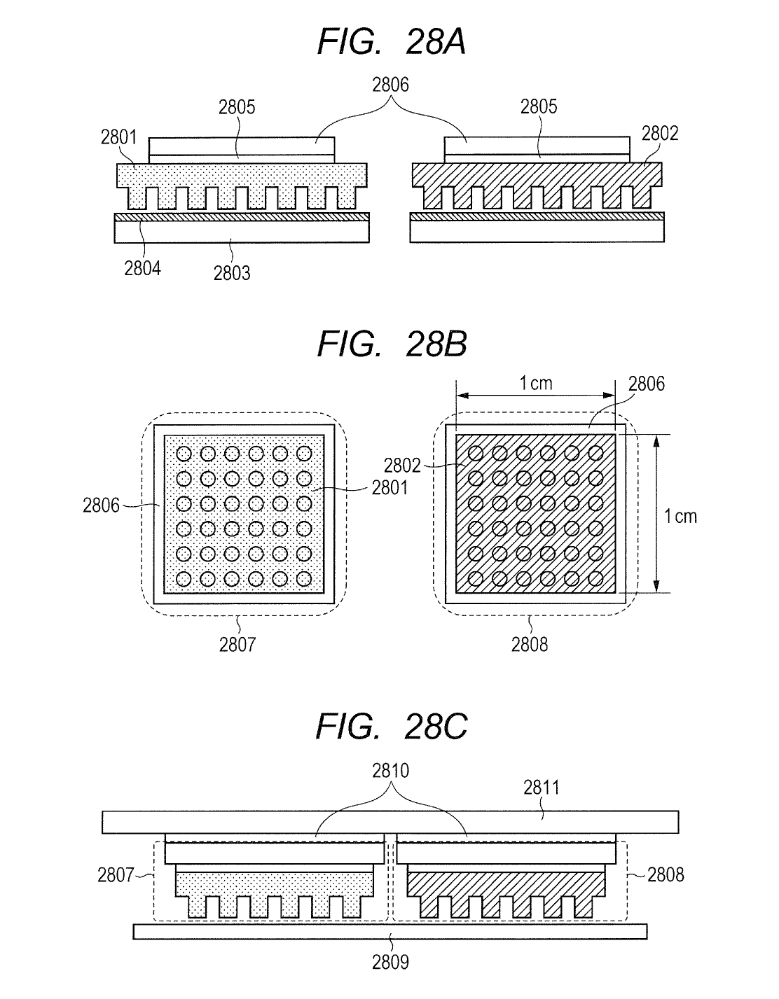

An additionally detailed production process is described with reference to FIG. 28A, FIG. 28B, and FIG. 28C. First, a PDMS sheet (2801, 2802) serving as a constituent member for the A portion or the B portion was produced by regulating a mixing ratio between a base polymer for the PDMS and a catalyst.

The production of the PDMS sheet in the A portion is as described below. First, the top of a resist pattern serving as a mold for protruding portions is spin-coated with a mixed liquid containing the base polymer for the PDMS and the catalyst at a ratio of 10:0.3, and then the liquid is thermally cured at 100° C. over 1 hour. The cycle is repeated 5 times. Then, the PDMS sheet (2801) is isolated by dissolving the resist with acetone, and is washed with acetone several times and dried in a vacuum. When the elastic modulus of the PDMS sheet was determined from a tensile load value at the time of a strain amount of 10%, the elastic modulus was 0.22 MPa.

The production of the PDMS sheet in the B portion is as described below. First, the top of a resist pattern is spin-coated with a mixed liquid containing the base polymer for the PDMS and the catalyst at a ratio of 10:3, and then the liquid is thermally cured at 100° C. over 1 hour. The cycle is repeated 7 times. Then, the PDMS sheet (2802) is isolated by dissolving the resist with acetone, and is washed with acetone several times and dried in a vacuum. When the elastic modulus of the PDMS sheet was determined from a tensile load value at the time of a strain amount of 10%, the elastic modulus was 1.8 MPa. Accordingly, it was confirmed that the PDMS sheet of the B portion had an elastic modulus 8.2 times as high as that of the PDMS sheet of the A portion.

Next, a process for the uniformization of the heights of the tips of the protruding portions in each of the A portion and the B portion was performed. The process is intended for an improvement in adhesive force of the final adhesive member. As illustrated in FIG. 28A, a glass wafer (2803) is spin-coated with an octane solution (2804) containing, at a mass ratio of 10%, a mixed liquid containing the base polymer for the PDMS and the catalyst at a ratio of 10:1, and each of the PDMS sheets is mounted on the surface of the wafer so that its protruding portions are brought into contact with the surface. Octane is evaporated and removed under a vacuum, and then the residue is thermally cured at 100° C. over 1 hour. A small amount of a mixed liquid (2805) containing the base polymer for the PDMS and the catalyst at a ratio of 10:1 is dropped to the upper surface of each of the PDMS sheets, and a glass substrate (2806) is mounted thereon, followed by thermal curing again under the same conditions. After that, the glass wafer in contact with the protruding portions is peeled in ethanol, and the remainder is dried in a vacuum. Finally, as illustrated in FIG. 28B, a 1-centimeter square portion is cut out of each of the PDMS sheets with a box cutter. Thus, the A portion (2807) and the B portion (2808) having the same size were produced.

Next, as illustrated in FIG. 28C, a glass wafer (2809) and the protruding portions are brought into contact with each other so that the A portion and the B portion (2807, 2808) are adjacent to each other, and under this state, a small amount of an epoxy-based adhesive (2810) is dropped to the upper surface of each of the glass substrates, and a glass substrate (2811) of such a size as to be capable of entirely fixing the upper surfaces of the A portion and the B portion is mounted thereon, followed by the adhesion of the three parts. Thus, the heights of the tips of the protruding portions of the A portion and the B portion are uniformized, and an adhesive member having a high adhesive force is obtained.

Finally, the adhesive member whose elastic modulus was nonuniformized was obtained by removing the glass wafer (2809).

<Actual Evaluation of Adhesion Profile>

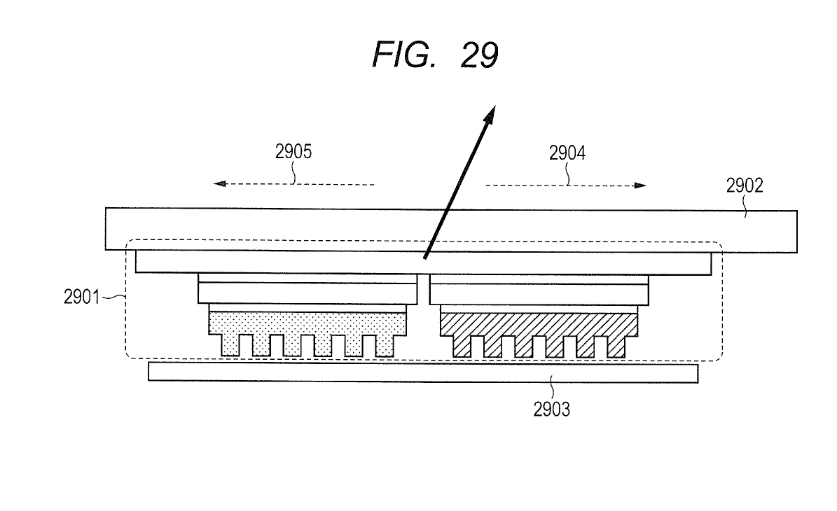

The adhesive force of the adhesive member of this example was evaluated with a tribology tester (UMT TriboLab, Bruker Co.). The apparatus has a triaxial force sensor and a triaxially driven linear actuator. As illustrated in FIG. 29, an adhesive member (2901) whose elastic modulus was nonuniformized described in the foregoing was fixed to a probe holder side in an upper portion. At this time, the adhesive member was fixed through a gel material (2902). In addition, a glass wafer (2903) was used as an adherend, and the wafer was fixed to a sample stage side in a lower portion.

The linear actuator was driven to bring the adhesive member and the adherend into contact with each other, and to adhere the adhesive member and the adherend to each other at a compressive load of 10 N. After that, the resultant was pulled up until a tensile load of 3 N was generated. Then, the adhesive member was slid in a first direction (2904) or a second direction (2905) at a speed of 0.1 mm/sec, and a force when the adhesive member peeled from the adherend was measured as an adhesive force.

When the adhesive member of this example was slid in the first direction, the force in a vertical direction component of the adhesive force was 3.5/Ncm⁻², and the force in a horizontal direction component thereof was 5.1/Ncm⁻². On the other hand, when the adhesive member was operated in the second direction, the force in the vertical direction component of the adhesive force was 2.7/Ncm⁻², and the force in the horizontal direction component thereof was −2.6/Ncm⁻². The foregoing forces substantially represent adhesive forces when the adhesive member is pulled up in left and right directions at angles of about 40° each relative to its adhesive surface. A ratio between the absolute values of the adhesive forces in the horizontal direction was 0.51, and hence the adhesive force of the adhesive member was found to show directional dependency.

It was confirmed from the foregoing that according to this example, the adhesive force of the adhesive member showed high directional dependency by virtue of the effect of causing the elastic moduli of the region including the first peeling site and the region including the second peeling site to differ from each other.

According to the present invention, adhesive forces in the case where a force is applied in a first direction and in the case where a force is applied in a second direction opposite thereto can be caused to differ from each other, and hence an adhesive member whose adhesive force has relatively strong directional dependency can be realized. In other words, the adhesive forces in the case where the force is applied in the first direction and in the case where the force is applied in the second direction are caused to differ from each other, and hence directional dependency can be produced in adhesive forces in different directions (not limited to the first direction and the second direction).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-088070, filed Apr. 23, 2015, which is hereby incorporated by reference herein in its entirety.

What is claimed is:

1. An adhesive member, which is configured to adhere to an adherend through an intersurface force, wherein when a strain energy release rate at a first peeling site of the adhesive member and an adhesive energy at the first peeling site in a case where a force is applied in a first direction parallel to an adhesive surface thereof are defined as G1^{a} and Δγ1^{a}, respectively, and a strain energy release rate at a second peeling site of the adhesive member and an adhesive energy at the second peeling site in a case where a force having the same magnitude as that of the force applied in the first direction is applied in a second direction opposite to the first direction are defined as G2^{a} and Δγ2^{a}, respectively, at least one of an elastic modulus and a Poisson's ratio of the adhesive member is nonuniformized so that G1^{a}/Δγ1^{a}≠G2^{a}/Δγ2^{a} is satisfied.

2. An adhesive member according to claim 1, wherein the adhesive member comprises a plurality of protruding portions configured to adhere to the adherend and a substrate portion configured to support the plurality of protruding portions, and the nonuniformization is performed in at least the substrate portion.

3. An adhesive member, which is configured to adhere to an adherend through an intersurface force, wherein:
at least one of an elastic modulus and a Poisson's ratio of the adhesive member is nonuniformized;
a horizontal section obtained by cutting the adhesive member along a plane parallel to an adhesive surface thereof has an asymmetrized shape;
when a strain energy release rate at a first peeling site of the adhesive member and an adhesive energy at the first peeling site in a case where a force is applied in a first direction parallel to the adhesive surface are defined as G1^{a,b} and Δγ1^{a,b}, respectively, and a strain energy release rate at a second peeling site of the adhesive member and an adhesive energy at the second peeling site in a case where a force having the same magnitude as that of the force applied in the first direction is applied in a second direction opposite to the first direction are defined as G2^{a,b} and Δγ2^{a,b}, respectively, G1^{a,b}/Δγ1^{a,b}≠G2^{a,b}/Δγ2^{a,b} is satisfied; and
the strain energy release rate G1^{a,b}, the adhesive energy Δγ1^{a,b}, the strain energy release rate G2^{a,b}, and the adhesive energy Δγ2^{a,b} are represented by G1^{a-,b}, Δγ1^{a-,b}, G2^{a-,b}, and Δγ2^{a-,b}, respectively in a case where the elastic modulus and the Poisson's ratio of the adhesive member are assumed to be uniform, and one of G1^{a,b}Δγ2^{a,b}/G2^{a,b}Δγ1^{a,b}<G1^{a-,b}Δγ2^{a-,b}/G2^{a-,b}Δγ1^{a-,b}<1 and G1^{a,b}Δγ2^{a,b}/G2^{a,b}Δγ1^{a,b}>G1^{a-,b}Δγ2^{a-,b}/G2^{a-,b}>1 is satisfied.

4. An adhesive member according to claim 3, wherein the adhesive member comprises a plurality of protruding portions configured to adhere to the adherend and a substrate portion configured to support the plurality of protruding portions, and the nonuniformization and the asymmetrization of the horizontal section are performed in at least the substrate portion.

5. An adhesive member, which is configured to adhere to an adherend through an intersurface force, wherein:
at least one of an elastic modulus and a Poisson's ratio of the adhesive member is nonuniformized;
when a strain energy release rate at a first peeling site of the adhesive member and an adhesive energy at the first peeling site in a case where a force is applied in a first direction parallel to an adhesive surface thereof are defined as G1^{a,c} and Δγ1^{a,c}, respectively, and a strain energy release rate at a second peeling site of the adhesive member and an adhesive energy at the second peeling site in a case where a force having the same magnitude as that of the force applied in the first direction is applied in a second direction opposite to the first direction are defined as G2^{a,c} and Δγ2^{a,c}, respectively, the Δγ1^{a,c} and the Δγ2^{a,c} differ from each other, and G1^{a,c}/Δγ1^{a,c}≠G2^{a,c}/Δγ2^{a,c} is satisfied; and
the strain energy release rate G1^{a,c}, the adhesive energy Δγ1^{a,c}, the strain energy release rate G2^{a,c}, and the adhesive energy Δγ2^{a,c} are represented by G1^{a-,c}, Δγ1^{a-,c}, G2^{a-,c}, and Δγ2^{a-,c}, respectively in a case where the elastic modulus and the Poisson's ratio of the adhesive member are assumed to be uniform, and one of G1^{a,c}Δγ2^{a,c}/G2^{a,c}Δγ1^{a,c}<G1^{a-,c}Δγ2^{a-,c}/G2^{a-,c}Δγ1^{a-,c}<1 and G1^{a,c}Δγ2^{a,c}/G2^{a,c}Δγ1^{a,c}>G1^{a-,c}Δγ2^{a-,c}/G2^{a-,c}Δγ1^{a-,c}>1 is satisfied.

6. An adhesive member according to claim 5, wherein the adhesive member comprises a plurality of protruding portions configured to adhere to the adherend and a substrate portion configured to support the plurality of protruding portions, and the nonuniformization is performed in at least the substrate portion.

7. An adhesive member, which is configured to adhere to an adherend through an intersurface force, wherein:
at least one of an elastic modulus and a Poisson's ratio of the adhesive member is nonuniformized;
a vertical section obtained by cutting the adhesive member along a surface vertical to an adhesive surface thereof and parallel to a first direction has a bilaterally asymmetrized shape;
when a strain energy release rate at a first peeling site of the adhesive member and an adhesive energy at the first peeling site in a case where a force is applied in the first direction parallel to the adhesive surface are defined as G1^{a,d} and Δγ1^{a,d}, respectively, and a strain energy release rate at a second peeling site of the adhesive member and an adhesive energy at the second peeling site in a case where a force having the same magnitude as that of the force applied in the first direction is applied in a second direction opposite to the first direction are defined as G2^{a,d} and Δγ2^{a,d}, respectively, G1^{a,d}/Δγ1^{a,d}≠G2^{a,d}/Δγ2^{a,d} is satisfied; and
the strain energy release rate G1^{a,d}, the adhesive energy Δγ1^{a,d}, the strain energy release rate G2^{a,d}, and the adhesive energy Δγ2^{a,d}, are represented by G1^{a-,d}, Δγ1^{a-,d}, G2^{a-,d}, and Δγ2^{a-,d}, respectively in a case where the elastic modulus and the Poisson's ratio of the adhesive member are assumed to be uniform, and one of G1^{a,d}Δγ2^{a,d}/G2^{a,d}Δγ1^{a,d}<G1^{a-,d}Δγ2^{a-,d}/G2^{a-,d}Δγ1^{a-,d}<1 and G1^{a,d}Δγ2^{a,d}/G2^{a,d}Δγ1^{a,d}>G1^{a-,d}Δγ2^{a-,d}/G2^{a-,d}Δγ1^{a-,d}>1 is satisfied.

8. An adhesive member according to claim 7, wherein the adhesive member comprises a plurality of protruding portions configured to adhere to the adherend and a substrate portion configured to support the plurality of protruding portions, and the nonuniformization and the bilateral asymmetrization of the vertical section are performed in at least the substrate portion.

9. An adhesive member according to claim 1, wherein the elastic modulus of the adhesive member is nonuniformized so that an average elastic modulus of one of two portions obtained by dividing the adhesive member along a direction vertical to the first direction and an average elastic modulus of another portion differ from each other.

10. An adhesive member according to claim 9, wherein a ratio of a larger one of the average elastic modulus of the one of the two portions and the average elastic modulus of the other portion to another is 5 or more.

11. An adhesive member according to claim 2, wherein the plurality of protruding portions have columnar shapes.

12. An adhesive member according to claim 4, wherein the plurality of protruding portions have columnar shapes.

13. An adhesive member according to claim 6, wherein the plurality of protruding portions have columnar shapes.

14. An adhesive member according to claim 8, wherein the plurality of protruding portions have columnar shapes.
